(19) United States
(12) Patent Application Publication
(10) Pub. No.: US 2026/0060875 A1
(43) Pub. Date: Mar. 5, 2026

(54) HANDS-FREE CRUTCH

(71) Applicant: Meng Zhang, Shenzhen (CN)

(72) Inventor: Meng Zhang, Shenzhen (CN)

(21) Appl. No.: 19/220,074

(22) Filed: May 27, 2025

(30) Foreign Application Priority Data
Sep. 2, 2024 (CN) 202422145413.0
Sep. 2, 2024 (CN) 202422150557.5
Nov. 28, 2024 (CN) 202430757033.5

(51) Int. Cl. A61H 3/02; A61H 3/00

(52) U.S. Cl. CPC A61H 3/0288; A61H 2003/005; A61H 2003/007

(57) ABSTRACT

A hands-free crutch includes: a mounting bracket and a support foot. The support foot includes: a bottom shell and a soft grounding member. The bottom shell is connected to a bottom of the mounting bracket. The bottom shell includes a front section, a middle section, and a rear section, which are sequentially connected to each other along a walking direction of a user; the front section and the rear section are both disposed away from a ground, and the middle section is disposed near the ground. The soft grounding member includes a first buffer section connected to the front section, a second buffer section connected to the middle section, and a third buffer section connected to the rear section. Each of a thickness of the first buffer section and a thickness of the third buffer section is greater than a thickness of the second buffer section.

### CROSS REFERENCE TO RELATED APPLICATIONS

The present application claims the priorities of: Chinese patent application No. 202422145413.0, filed on Sep. 2, 2024; Chinese patent application No. 202422150557.5, filed on Sep. 2, 2024; and Chinese design application No. 202430757033.5, filed on Nov. 28, 2024; and contents of which are incorporated herein by their entireties.

### TECHNICAL FIELD

The present disclosure relates to the field of electronic crutches, and in particular to a hands-free crutch.

### BACKGROUND

A bottom support foot of a crutch in the art is structurally rigid and cannot effectively simulate posture changes of a real human foot during walking. Therefore, the crutch in the art may be used less comfortably, causing physical discomfort for a user during walking.

### SUMMARY OF THE DISCLOSURE

The present disclosure provides a hands-free crutch, including: a mounting bracket and a support foot. The support foot includes: a bottom shell and a soft grounding member. The bottom shell is connected to a bottom of the mounting bracket. The bottom shell includes a front section, a middle section, and a rear section; the front section, the middle section, and the rear section are sequentially connected to each other along a walking direction of a user; the front section and the rear section are both disposed away from a ground, and the middle section is disposed near the ground. The soft grounding member includes a first buffer section, a second buffer section, and a third buffer section. The first buffer section is connected to the front section, the second buffer section is connected to the middle section, and the third buffer section is connected to the rear section; each of a thickness of the first buffer section and a thickness of the third buffer section is greater than a thickness of the second buffer section.

### BRIEF DESCRIPTION OF THE DRAWINGS

In order to more clearly illustrate the embodiments of the present disclosure or in the related art, drawings used for describing the embodiments or the related art will be briefly introduced below. Obviously, the drawings in the following description are only some embodiments of the present disclosure. Any ordinary skilled person in the art may obtain other drawings based on these drawings without creative work.

FIG. 1 is a first perspective view of a hands-free crutch according to a first embodiment of the present disclosure.

FIG. 2 is a second perspective view of the hands-free crutch according to the first embodiment of the present disclosure.

FIG. 3 is a structural schematic view of a bearing component of the hands-free crutch according to the first embodiment of the present disclosure.

FIG. 4 is a schematic view of connection between a portion of a support component and a leg protection component of the hands-free crutch according to the first embodiment of the present disclosure.

FIG. 5 is an exploded view of the leg protection component of the hands-free crutch according to the first embodiment of the present disclosure.

FIG. 6 is a partial structural schematic view of the leg protection component of the hands-free crutch according to the first embodiment of the present disclosure.

FIG. 7 is a structural schematic view of a leg protection bracket of the hands-free crutch according to the first embodiment of the present disclosure.

FIG. 8 is a structural schematic view of a rotation member of the hands-free crutch according to the first embodiment of the present disclosure.

FIG. 9 is a structural schematic view of a reinforcing member of the hands-free crutch according to the first embodiment of the present disclosure.

FIG. 10 is a structural schematic view of a binding component of the hands-free crutch according to the first embodiment of the present disclosure.

FIG. 11 is a first exploded view of a first binding structure of the hands-free crutch according to the first embodiment of the present disclosure.

FIG. 12 is a second exploded view of the first binding structure of the hands-free crutch according to the first embodiment of the present disclosure.

FIG. 13 is a first structural schematic view of the second binding structure of the hands-free crutch according to the first embodiment of the present disclosure.

FIG. 14 is a second structural schematic view of the second binding structure of the hands-free crutch according to the first embodiment of the present disclosure.

FIG. 15 is a structural schematic view of the entire hands-free crutch according to the first embodiment of the present disclosure.

FIG. 16 is an exploded view of the entire hands-free crutch according to the first embodiment of the present disclosure.

FIG. 17 is a first structural schematic view of a bottom shell and a soft grounding member of the hands-free crutch according to the first embodiment of the present disclosure.

FIG. 18 is a second structural schematic view of the bottom shell and the soft grounding member of the hands-free crutch according to the first embodiment of the present disclosure.

FIG. 19 is a schematic view of the hands-free crutch taking a third buffer section to be in contact with the ground according to the first embodiment of the present disclosure.

FIG. 20 is a schematic view of the hands-free crutch taking a first buffer section to be in contact with the ground according to the first embodiment of the present disclosure.

FIG. 21 is a first exploded view of a support foot of the hands-free crutch according to the first embodiment of the present disclosure.

FIG. 22 is a second exploded view of the support foot of the hands-free crutch according to the first embodiment of the present disclosure.

FIG. 23 is a schematic view of connection of the support foot, a master support rod, and a limiting ring of the hands-free crutch according to the first embodiment of the present disclosure.

FIG. 24 is a cross-sectional view of the support foot, the master support rod, and the limiting ring of the hands-free crutch according to the first embodiment of the present disclosure.

FIG. 25 is a schematic view of a top of the bottom shell of the hands-free crutch according to the first embodiment of the present disclosure.

FIG. 26 is a schematic view of connection of the master support rod and a mounting rod of the hands-free crutch according to the first embodiment of the present disclosure.

FIG. 27 is a cross-sectional view of the master support rod, the mounting rod, and a vibration damping component of the hands-free crutch according to the first embodiment of the present disclosure.

FIG. 28 is a structural schematic view of a locking ring of the hands-free crutch according to the first embodiment of the present disclosure.

FIG. 29 is a first structural schematic diagram of the vibration damping component mounted on a top of the master support rod of the hands-free crutch according to the first embodiment of the present disclosure.

FIG. 30 is a second structural schematic view of the vibration vibration damping component mounted on the top of the master support rod of the hands-free crutch according to the first embodiment of the present disclosure.

FIG. 31 is an exploded view of the vibration damping component of the hands-free crutch according to the first embodiment of the present disclosure.

FIG. 32 is a structural schematic view of a bearing member and a soft buffer pad of the hands-free crutch according to the first embodiment of the present disclosure.

FIG. 33 is a first perspective view of the hands-free crutch according to a second embodiment of the present disclosure.

FIG. 34 is a second perspective view of the hands-free crutch according to the second embodiment of the present disclosure.

FIG. 35 is a perspective view of the hands-free crutch according to a third embodiment of the present disclosure.

FIG. 36 is a first perspective view of the hands-free crutch according to a fourth embodiment of the present disclosure.

FIG. 37 is a second perspective view of the hands-free crutch according to the fourth embodiment of the present disclosure.

FIG. 38 is a perspective view of the hands-free crutch according to a fifth embodiment of the present disclosure.

FIG. 39 is an exploded view of the leg protection component of the hands-free crutch according to the fifth embodiment of the present disclosure.

FIG. 40 is a first perspective view of the leg protection bracket of the hands-free crutch according to the fifth embodiment of the present disclosure.

FIG. 41 is a second perspective view of the leg protection bracket of the hands-free crutch according to the fifth embodiment of the present disclosure.

FIG. 42 is a first perspective view of the rotation member of the hands-free crutch according to the fifth embodiment of the present disclosure.

FIG. 43 is a second perspective view of the rotation member of the hands-free crutch according to the fifth embodiment of the present disclosure.

FIG. 44 is a perspective view of an elastic member of the hands-free crutch according to the fifth embodiment of the present disclosure.

FIG. 45 is a perspective view of the reinforcing member of the hands-free crutch according to the fifth embodiment of the present disclosure.

FIG. 46 is a structural schematic diagram of the vibration damping component mounted on a top of the master support rod of the hands-free crutch according to another embodiment of the present disclosure.

FIG. 47 is an exploded view of the vibration damping component and the master support rod of the hands-free crutch according to another embodiment of the present disclosure.

FIG. 48 is a cross-sectional view of the vibration damping component mounted on the master support rod as shown in FIG. 46.

FIG. 49 is an exploded view of the vibration damping component and the master support rod of the hands-free crutch shown in FIG. 47, being viewed from another viewing angle.

FIG. 50 is a disassembled and cross-sectional view of the vibration damping component and the master support rod as shown in FIG. 47.

FIG. 51 is another disassembled and cross-sectional view of the vibration damping component and the master support rod as shown in FIG. 47.

### REFERENCE NUMERALS IN THE DRAWINGS

10a, hands-free crutch; 11a, receiving space; 12a, receiving space;
100a, bearing component; 110a, bearing body;
200a, support component; 210a, master support rod;
300a, leg protection component; 310a, leg protection bracket; 311a, first connection sleeve; 3111a, first mounting slot; 3112a, second mounting slot; 3113a, third mounting slot; 3114a, first limiting structure; 3115a, third control hole; 312a, bracket body; 313a, third connection sleeve; 3131a, second control hole; 3132a, positioning block; 314a, handle; 315a, reinforcing rib; 316a, reinforcing rib; 317a, gap; 318a, limiting column; 319a, through hole; 320a, rotation member; 321a, protection portion; 3211a, inner surface; 3212a, outer surface; 3213a, shaft hole; 322a, second connection sleeve; 3221a, through hole; 3222a, flange; 323a, fourth mounting slot; 324a, second limiting structure; 325a, reinforcing rib; 330a, elastic member; 331a, first elastic portion; 332a, second elastic portion; 333a, third elastic portion; 340a, control assembly; 341a, first control member; 3411a, control portion; 3412a, connection portion; 3413a, anti-slip structure; 342a, elastic member; 343a, reinforcing portion; 3431a, screw hole; 3432a, fourth control hole; 3433a, positioning slot; 344a, second control member; 350a, connection rod; 351a, third connection hole; 352a, fourth connection hole; 360a, adjustment rod; 361a, adjustment hole; 362a, first control hole; 370a, adjustment assembly; 380a, stabilizing member; 390a, second leg protection member; 391a, first sleeve portion; 392a, second sleeve portion; 393a, leg protection portion; 301a, first leg protection member; 302a, cap;
400a, binding component; 410a, first binding structure; 420a, second binding structure; 430a, binding belt; 411a, first fixation member; 4111a, shaft hole; 4112a, shaft hole; 4113a, first fixation body; 4114a, first fixation plate; 4115a, first buckle portion; 412a, first fixation bracket; 4121a, shaft hole; 4122a, shaft hole; 4123a, first slide slot; 4124a, second slide slot; 4125a, sliding space; 4126a, slide hole; 413a, first binding member; 4131a, first slide portion; 4132a, second slide portion; 4133a, second buckle portion; 4134a, buckle slot; 4135a, avoidance slot; 4136a, third slide portion; 414a, elastic member; 415a, first shaft; 416a, second shaft; 417a, third shaft; 421a, second fixation member; 4211a, shaft hole; 4212a, shaft hole; 4213a, second fixation body; 4214a, second fixation plate; 422a, second binding member; 4221a, shaft hole; 4222a, binding slot; 4223a, limiting space; 4224a, binding body; 4225a, first limiting plate; 4226a, second limiting plate; 423a, fourth shaft; 424a, elastic member; 425a, fifth shaft; 431a, belt body; 432a, fixation body; 4321a, notch; 4322a, shaft hole; 433a, toothed strip; 434a, tooth slot; 4201a, binding entrance; 4202a, binding exit; 4203a, binding channel;
D1, length direction of the bearing body; D2, width direction of the bearing body; D3, thickness direction of the support foot;
11g, mounting bracket; 12g, support foot;
111g, master support rod; 112g, limiting ring; 113g, locking bolt; 114g, bearing component; 115g, vibration damping component; 116g, locking component; 1111g, first limiting notch; 1112g, second snap slot; 1113g, third limiting notch; 1121g, second limiting notch; 1141g, mounting rod; 1142g, bearing member; 1143g, soft buffer pad; 1151g, upper mounting member; 1152g, lower mounting member; 1153g, elastic member; 1161g, positioning rod; 1162g, locking ring; 11411g, first end; 11412g, second end; 11413g, positioning hole; 11421g, top surface of the bearing member; 11422g, first groove; 11431g, top surface of the soft buffer pad; 11432g, second groove; 11433g, third groove; 11511g, upper abutting plate; 11512g, upper sleeve; 11513g, first snap; 11514g, guide protrusion; 11521g, lower abutting plate; 11522g, lower sleeve; 11523g, first snap slot; 11524g, second snap; 11525g, guide notch; 11526g, second limiting protrusion; 11527g, insertion protrusion; 11621g, annular body; 11622g, flexible locking belt; 11623g, annular opening; 11624g, third end; 11625g, fourth end; 11626g, fixation groove; 11627g, locking hook; 11628g, hook;
121g, bottom shell; 122g, soft grounding member; 1210g, cavity; 1211g, bottom of the bottom shell; 1212g, top of the bottom shell; 1213g, front section; 1214g, middle section; 1215g, rear section; 1216g, first curved connection surface; 1217g, embedding cavity; 1218g, partition plate; 1219g, insertion slot; 1222g, contact surface; 1223g, first buffer section; 1224g, second buffer section; 1225g, third buffer section; 1226g, second curved connection surface; 1227g, embedding protrusion; 1228g, anti-slip structure; 12281g, anti-slip protrusion; 12131g, bottom surface of the front section; 12141g, bottom surface of the middle section; 12151g, bottom surface of the rear section; 12171g, opening; 12191g, first limiting protrusion; 12231g, top surface of the first buffer section; 12232g, bottom surface of the first buffer section; 12241g, top surface of the second buffer section; 12242g, bottom surface of the second buffer section; 12251g, top surface of the third buffer section; 12252g, bottom surface of the third buffer section; S, central portion of the soft grounding member;
10b, hands-free crutch; 11b, receiving space; 100b, bearing component; 200b, support component; 300b, leg protection component; 310b, leg protection bracket; 360b, adjustment rod; 400b, binding component; 410b, first binding structure; 420b, second binding structure;
10c, hands-free crutch; 100c, bearing component; 110c, bearing body; 111c, binding portion; 112c, binding hole; 200c, support component; 300c, leg protection component; 360c, adjustment rod; 400c, binding component; 401c, first belt body; 402c, second belt body; 403c, connection member;
10d, hands-free crutch; 100d, bearing component; 110d, bearing body; 200d, support component; 300d, leg protection component; 400d, binding component;
10e, hands-free crutch; 100e, bearing component; 200e, support component; 220e, movable assembly; 221e, pin; 222e, fastening structure; 2221e, fastening ring; 2222e, opening; 2223e, fastening buckle; 2224e, buckle portion; 2225e, rotation portion; 300e, leg protection component; 302e, cap; 310e, leg protection bracket; 311e, sleeve portion; 3111e, first elastic hole; 3112e, second elastic hole; 3113e, third elastic hole; 3115e, third control hole; 312e, bracket body; 3121e, first limiting structure; 314e, handle; 316e, reinforcing rib; 319e, through hole; 320e, rotation member; 321e, protection portion; 322e, first rotation portion; 3221e, rotation hole; 3222e, mounting slot; 3224e, weight reduction slot; 323e, second rotation portion; 3231e, rotation hole; 3232e, fourth mounting slot; 3233e, weight reduction slot; 324e, second limiting structure; 330e, elastic member; 331e, first elastic portion; 332e, second elastic portion; 333e, third elastic portion; 334e, fourth elastic portion; 340e, control assembly; 341e, first control member; 342e, gasket; 343e, reinforcing member; 3431e, screw hole; 3432e, screw hole; 3433e, positioning slot; 3434e, positioning block; 3435e, protrusion; 3436e, first insertion portion; 3437e, second insertion portion; 344e, second control member; 350e, connection rod; 360e, adjustment rod; 363e, positioning notch; 370e, adjustment assembly; 390e, second leg protection member; 400e, binding component.

### DETAILED DESCRIPTION

Unless otherwise defined, all technical and scientific terms used herein have the same meanings as being commonly understood by any ordinary skilled person in the art. The terms used herein in the specification of the present disclosure are used only for the purpose of describing specific embodiments and shall not be interpreted as limiting the present disclosure. The terms “include” and “have” and any variations thereof, used in the specification, claims and the drawings of the present disclosure are intended to cover non-exclusive embodiments. The terms “first”, “second”, and so on in the specification, claims and the accompanying drawings of the present disclosure are used to distinguish between different objects and are not used to describe a particular order.

Reference to “embodiments” herein implies that particular features, structures, or characteristics described in an embodiment may be included in at least one embodiment of the present disclosure. The presence of the phrase at various sections in the specification does not necessarily refer to the same embodiment, nor a separate or alternative embodiment that is mutually exclusive of other embodiments. It is understood by any ordinary skilled person in the art, both explicitly and implicitly, that the embodiments described herein may be combined with other embodiments.

In order to allow any ordinary skilled person in the art to better understand the embodiments of the present disclosure, technical solutions in the embodiments of the present disclosure will be clearly and completely described below by referring to the accompanying drawings.

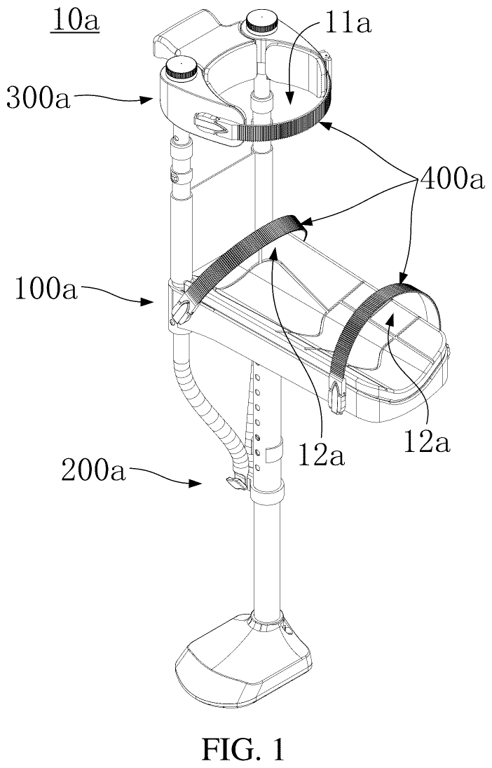

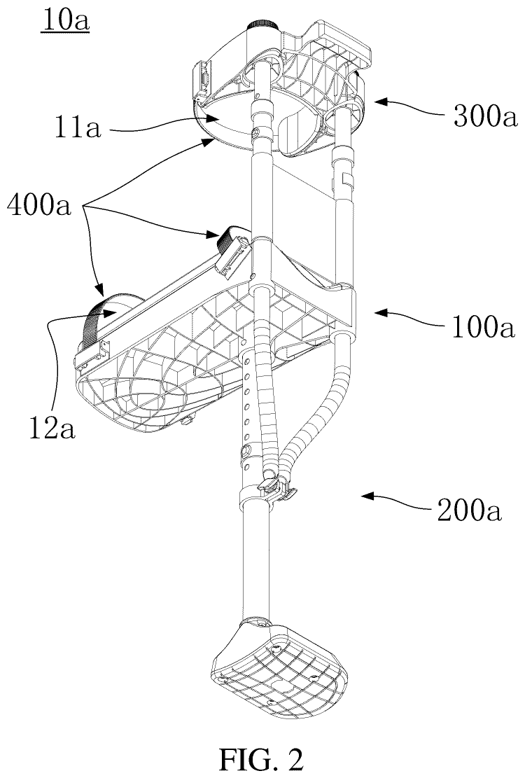

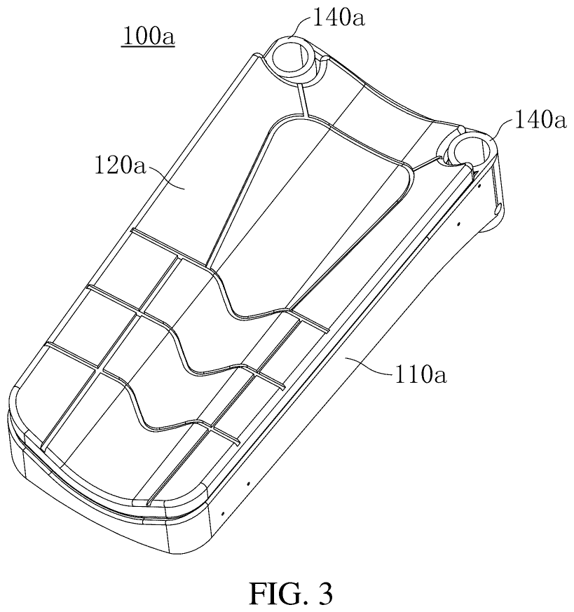

As shown in FIGS. 1 and 2, the hands-free crutch 10a may include a bearing component 100a, a support component 200a, and a leg protection component 300a. The support component 200a and the leg protection component 300a are both connected to the bearing component 400a.

The bearing component 100a has a first surface and a second surface faces away from the first surface, that is, the first surface and the second surface are two opposite surfaces. The first surface may be configured to at least bear a knee of a user. To be noted that the first surface may further be configured to bear a calf of the user. In the present disclosure, the first surface may be interpreted as a bearing surface of the bearing component 100a, and the second surface may be interpreted as a rear surface of the bearing component 100a.

In an example, the leg protection component 300a may be at least partially disposed at an outer side of the first surface of the bearing component 100a. The leg protection component 300a may at least protect a thigh of the user. The support component 200a may at least partially be disposed at an outer side of the second surface of the bearing component 100a. The support component 200a may support the bearing component 100a and the leg protection component 300a.

When the hands-free crutch 10a is in an upright state, an end of the support component 200a away from the bearing component 100a may be supported on a support surface such as the ground, and at this moment, the second surface may be located below the first surface, and the leg protection component 300a may be located above the support component 200a.

The leg protection component 300a may be mounted on the bearing component 100a. The leg protection component 300a may be configured to protect the knee placed on a bearing pad and protect the thigh of the user. Specifically, the leg protection component 300a may further include a leg protection member connected to the connection rod 350a. In addition, the leg protection component 300a may further bind the thigh of the user to the leg protection component 300a to facilitate the user to walk.

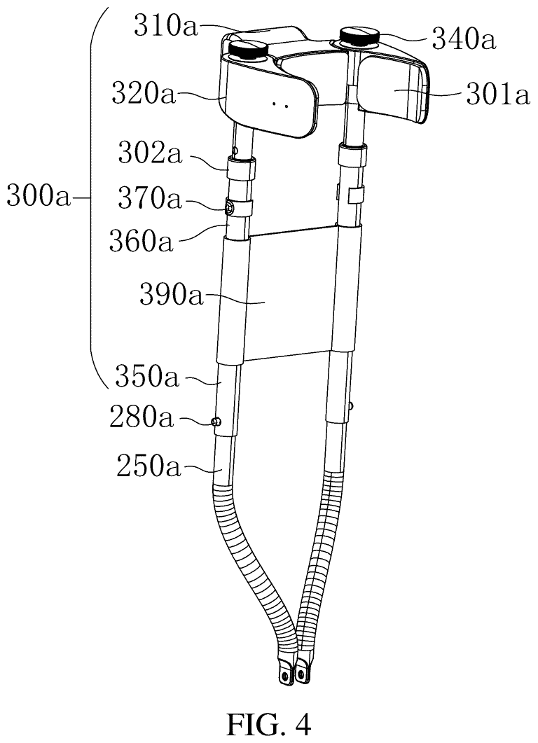

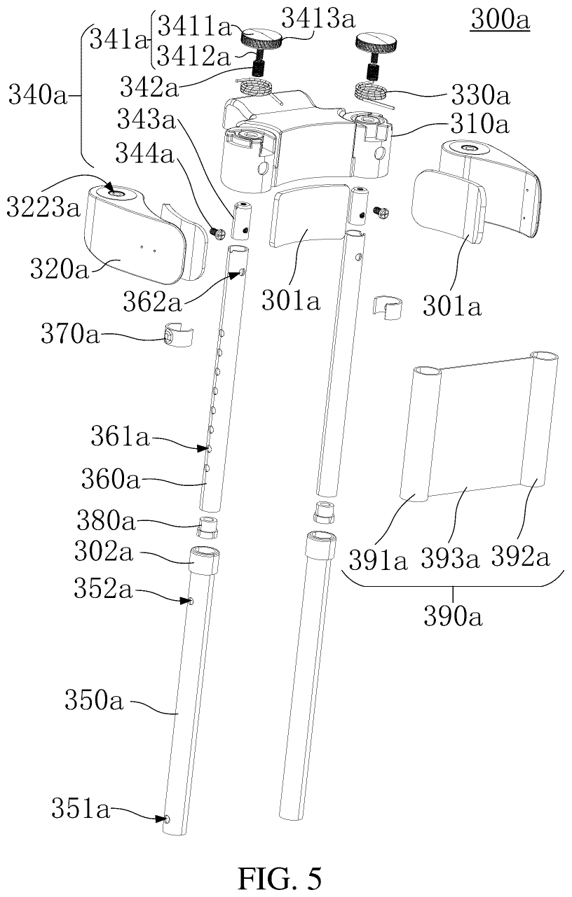

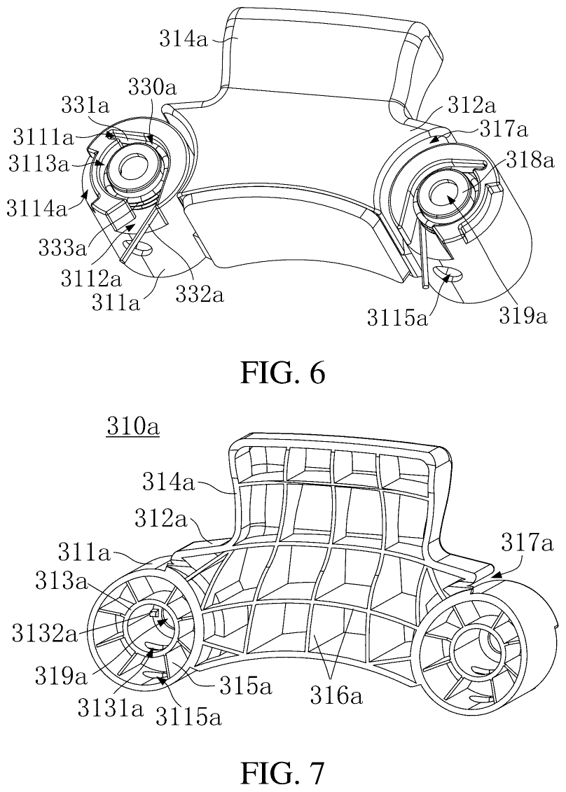

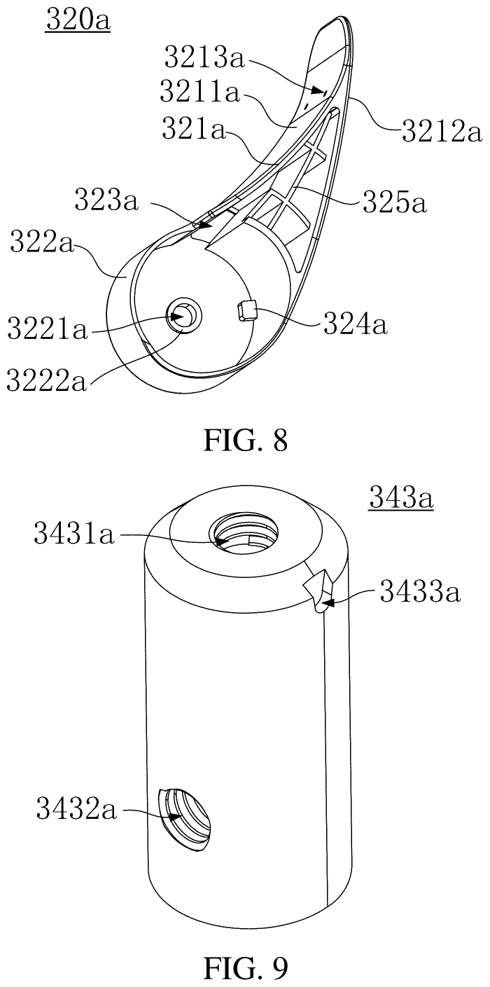

As shown in FIGS. 4 to 9, the leg protection component 300a may include a leg protection bracket 310a and at least one rotation member 320a. The at least one rotation member 320a may be rotatably connected to the leg protection bracket 310a. The at least one rotation member 320a may be rotatable with respect to the leg protection bracket 310a. The number of the at least one rotation member 320a may be one, two, or other numbers. An example in which the number of the at least one rotation member 320a is two will be described. The two rotation members 320a may be respectively rotatably connected to two sides of the leg protection bracket 310a. In other words, the two rotation members 320a may be mounted on the leg protection bracket 310a, and the two rotation members 320a may be rotatable, under a first condition, on the leg protection bracket 310a. Under a second condition, the two rotation members 320a may be fastened to the leg protection bracket 310a and cannot rotate. The two rotation members 320a and the leg protection bracket 310a may cooperatively protect the thigh of the user. For example, the two rotation members 320a and the leg protection bracket 310a may be detachably connected to each other, such that the crutch may be conveniently transported and stored.

For example, a part of each rotation member 320a and a part of the leg protection bracket 310a may be sleevedly connected to each other to achieve relative rotation. For example, the leg protection bracket 310a may include a bracket body 312a and at least one first connection sleeve 311a connected to a side of the bracket body 312a. The present disclosure will be described by arranging two first connection sleeves 311a as an example. It can be understood that one first connection sleeve 311a may be disposed on a side of the bracket body 312a, and the other first connection sleeve 311a may be disposed on the other side of the bracket body 312a. The rotation member 320a may include a protection portion 321a and a second connection sleeve 322a connected to the protection portion 321a. For example, the first connection sleeve 311a and the second connection sleeve 322a are sleevedly connected to each other and are rotatable relative to each other. The present disclosure will be described by taking the second connection sleeve 322a sleeving the first connection sleeve 311a as an example. It should be understood that the first connection sleeve 311a may alternatively sleeve the second connection sleeve 322a.

A gap 317a may be defined between the first connection sleeve 311a and a bracket body 312a. The gap 317a may be located on a side of the leg protection bracket 310a away from the bearing component 100a. The gap 317a may be arc-shaped, and the gap 317a may receive a part of the second connection sleeve 322a. In this way, the second connection sleeve 322a is facilitated to sleeve the first connection sleeve 311a, and for the second connection sleeve 322a is facilitated to be rotatable with respect to the first connection sleeve 311a.

In practice, the two rotation members 320a and the leg protection bracket may be configured to cooperatively protect the leg such as the thigh placed on the bearing pad 120a. Generally, a receiving space 11a defined by the two rotation members 320a and the leg protection bracket 310a may receive the thigh. The two rotation members 320a may be rotatable relative to the leg protection bracket 310a. On the one hand, a size of the receiving space defined by the two rotation members 320a and the leg protection bracket 310a may be adapted to thighs of various sizes. On the other hand, since the two rotation members 320a are rotatable relative to the leg protection bracket 310a, the two rotation members 320a may be easily bound, by an external component such as a binding belt, to the thigh. During binding, the two rotation members 320a may be easily controlled to rotate to reach a more comfortable position on the thigh. Therefore, in practice, a rotation range of the rotation members 320a may be limited, that is, the rotation members 320a may not need to rotate excessively. Therefore, in the present disclosure, a limiting structure may be arranged between the two rotation members 320a and the leg protection bracket 310a to limit the rotation range of the two rotation members 320a, such that the two rotation members 320a may be limited to a required rotation range. For example, a rotation range of any rotation member 320a may be limited to an acute angle, or a rotation arc of any rotation member 320a may be less than 90 degrees. It can be understood that, in other cases, the additional limiting structure for limiting the rotation range of the two rotation members 320a may be omitted.

For example, the leg protection bracket 310a may be arranged with two first limiting structures 3114a. One of the two first limiting structures 3114a may be arranged on one first connection sleeve 311a. For example, one first limiting structure 3114a may be arranged on a side of the one first connection sleeve 311a away from the bearing component 100a. The rotation member 320a may be arranged with a second limiting structure 324a. The first limiting structure 3114a and the second limiting structure 324a may be movable relative to each other and limit each other to limit the rotation range, or the angle of the rotation arc, of the two rotation members 320a relative to the leg protection bracket 310a.

For example, one of the first limiting structure 3114a and the second limiting structure 324a may be a limiting groove, and the other one of the first limiting structure 3114a and the second limiting structure 324a may be a limiting block. The limiting block may be received in the limiting groove and may be movable in the limiting groove. For example, the first limiting structure 3114a may be the limiting groove 3114a, and the second limiting structure 324a may be the limiting block 324a. During the rotation member 320a rotating relative to the leg protection bracket 310a, the limiting block 324a may move in the limiting groove 3114a. Groove side walls that define the limiting groove 3114a may abut against the limiting block 324a to limit the limiting block 324a, such that a limiting effect on the rotation member 320a may be achieved. Therefore, the rotation range of the rotation member 320a may be limited by a size relationship between a size of the limiting groove 3114a and a size of the limiting block 324a. The size relationship between the size of the limiting groove 3114a and the size of the limiting block 324a may be determined according to actual needs, which is not limited herein.

For example, the limiting groove 3114a may be an arc groove, and the limiting groove 3114a may be larger than the limiting block in size.

For example, the leg protection component 300a may further include at least one elastic member 330a, and the number of the at least one elastic member 330a may be one, two, or other numbers. For example, the number of the at least one elastic member 330a may be the same as the number of the at least one rotation member 320a. Two elastic members 330a may be mounted between the leg protection bracket 310a and the rotation members. For example, one of the two elastic members 330a may be mounted on one first connection sleeve 311a. When one rotation member 320a rotates relative to the leg protection bracket 310a, one elastic member 330a may be driven to be elastically deformed. For example, the elastic member 330a may include a compression spring or a torsion spring, and the torsion spring may be configured in the present disclosure.

For example, any elastic member 330a may include a first elastic portion 331a, a second elastic portion 332a, and a third elastic portion 333a. The third elastic portion 333a is connected to the first elastic portion 331a and the second elastic portion 332a. For example, the first elastic portion 331a, the second elastic portion 332a, and the third elastic portion 333a may be configured as an integral and one-piece structure. The first elastic portion 331a and the third elastic portion 333a may be mounted on the leg protection bracket 310a. At least part of the second elastic portion 332a may extend to an outside the leg protection bracket 310a. At least part of the second elastic portion 332a may be mounted on the rotation member 320a. For example, a part of the second elastic portion 332a may be disposed inside the leg protection bracket 310a, and the other part of the second elastic portion 332a may be connected to the rotation member 320a.

For example, the leg protection bracket 310a defines a first mounting slot 3111a, a second mounting slot 3112a, and a third mounting slot 3113a, which are communicated with each other. The first mounting slot 3111a, the second mounting slot 3112a, and the third mounting slot 3113a may be defined in a side of the first connection sleeve 311a away from the bearing component 100a. The first elastic member 331a may be received in the first mounting slot 3111a, and the third elastic member 333a may be received in the third mounting slot 3113a. The second mounting slot 3112a may be communicated to an opening defined in a side wall of the leg protection bracket 310a. In this way, the at least part of the second elastic member 332a may pass through the second mounting slot 3112a to further extend to the outside of the leg protection bracket 310a. In other words, the at least part of the second elastic member 332a may extend to the outside of the leg protection bracket 310a from the second mounting slot 3112a. For example, a part of the second elastic member 332a may be received in the second mounting slot 3112a, and the rest part of the second elastic member 332a may extend to the outside of the leg protection bracket 310a to be arranged on the rotation member 320a.

For example, the rotation member 320a defines a fourth mounting slot 323a to receive the second elastic member 332a. In practice, the elastic member 330a may be mounted on the leg protection bracket 310a firstly, and a part of the second elastic member 332a may be subsequently received in the fourth mounting slot 323 a of the rotation member 320a. During the rotation member 320a rotating relative to the leg protection bracket 310a, at least the second elastic member 332a may be driven to be deformed. Alternatively, during a process of the rotation member 320a driving at least the second elastic member 332a to be deformed, the rotation member 320a rotates relative to the leg protection bracket 310a.

In other embodiments, the third elastic member 333a may be annular or spiral-shaped. In the present disclosure, the third elastic member 333a may be spiral-shaped. During the rotation member 320a rotating relative to the leg protection bracket 310a, the second elastic member 332a and the third elastic member 333a may both be driven to be deformed.

In an example, the third mounting slot 3113a may be annular.

In an example, the leg protection bracket 310a may include a limiting column 318a. The third elastic member 333a may sleeve the limiting column 318a. The limiting column 318a may be arranged on a side of the first connection sleeve 311a away from the bearing component 100a.

In some embodiments, any elastic member 330a may include the first elastic portion 331a and the second elastic portion 332a, but may not include the third elastic portion 333a.

In some embodiments, any elastic member 330a may include the first elastic portion 331a and the third elastic portion 333a, but may not include the second elastic portion 332a.

The leg protection component 300a may further include at least one control assembly 340a. The present embodiment will be described by taking two control assemblies 340a as an example. One of the two control assemblies 340a may be at least connected to one rotation member 320a and the leg protection bracket 310a to connect the rotation member 320a with the leg protection bracket 310a. In an example, the one control assembly 340a may be detachably connected to the rotation member 320a and the leg protection bracket 310a.

For example, the one control assembly 340a may be at least detachably connected to the rotation member 320a and the first connection sleeve 311a.

For example, each control assembly 340a may include a first control member 341a, and the first control member 341a may be detachably connected to one rotation member 320a and the first connection sleeve 311a. For example, the control assembly 340a may extend through the rotation member 320a to be detachably connected to the first connection sleeve 311a.

For example, the first control member 341a may include a control portion 3411a and a connection portion 3412a. The connection portion 3412a may be arranged on a side of the control portion 3411a. An outer surface of the connection portion 3412a may have threads. The connection portion 3412a may be detachably connected to the rotation member 320a and the first connection sleeve 311a. For example, the connection portion 3412a may pass through the rotation member 320a to be detachably connected to the first connection sleeve 311a. The control portion 3411a may press the rotation member 320a to achieve connection between the rotation member 320a and the first connection sleeve 311a.

For example, the control portion 3411a may be disk-shaped. In an example, an edge of the control portion 3411a may be arranged with an anti-slip structure 3413a, facilitating the user to operate the control portion 3411a by hand. The anti-slip structure 3413a may include a plurality of anti-slip strips that are spaced apart from each other.

In an example, the control assembly 340a may further include an elastic member 342a. The elastic member 342a may be limited between the first control member 341a and the first connection sleeve 311a. The elastic member 342a may be elastically deformed and may be switched between a compressed state and an extended state. The elastic member 342a may have an elastic force in the compressed state. The first control member 341a, when connecting to the rotation member 320a and the first connection sleeve 311a, may compress the elastic member 342a. For example, the elastic member 342a may be sleevedly connected to the connection member 3412a, and an end of the elastic member 342a may abut against a side of the control portion 3411a. The other end of the elastic member 342a may abut against a surface of the first connection sleeve 311a. It should be understood that the elastic member 342a, regardless of being in the compressed state or in the extended state, may be sleevedly connected to the part of the connection member 3412a.

For example, the first condition may be understood as the elastic member 342a being in the extended state. The connection portion 3412a may be connected to the rotation member 320a and the first connection sleeve 311a, however, the control portion 3411a does not press the elastic member 342a. That is, the rotation member 320a and the first connection sleeve 311a are not pressed, such that the rotation member 320a may be rotatable relative to the first connection sleeve 311a.

For example, the second condition may be understood as the elastic member 342a being in the compressed state. The connection portion 3412a may be connected to the rotation member 320a and the first connection sleeve 311a, and the control portion 3411a presses the elastic member 342a. That is, the rotation member 320a and the first connection sleeve 311a are pressed, such that the rotation member 320a and the first connection sleeve 311a are secured to each other.

It should be noted that the first condition and the second condition may not be limited thereto. For example, the first control member 340a may be configured to press the rotation member 320a and the first connection sleeve 311a, or loosen a pressure applied to the rotation member 320a and the first connection sleeve 311a to facilitate the rotation member 320a to rotate relative to the first connection sleeve 311a. Other structures may be arranged to cooperatively press the rotation member 320a and the first connection sleeve 311a or to loosen the pressure applied to the rotation member 320a and the first connection sleeve 311a.

For example, the rotation member 320a has a through hole 3221a, and the connection portion 3412a may pass through the through hole. The through hole 3221a may be defined at an end of the second connection sleeve 322a. The rotation member 320a has a groove 3223a communicated with the through hole 3221a, and the groove 3223a may receive an end of the elastic member 342a. In this way, when the elastic member 342a is in the compressed state, a distance between the control portion 3411a and the second connection sleeve 322a may not be excessively large. In addition, the groove 3223a may limit a position of the elastic member 342a. For example, the rotation member 320a may further include a flange 3222a. The flange 3222a may be arranged surrounding the through hole 3221a, and the flange 3222a and the groove 3223a are located at corresponding positions, so as to increase a capability of the rotation member 320a to bear a compression force of the elastic member 342a.

For example, the leg protection bracket 310a has a through hole 319a, and the connection portion 3412a may extend through the through hole. For example, the through hole 319a may extend through the limiting column 318a.

For example, a hole wall for forming the through hole 3221a may be arranged with threads. The wall forming the through hole 319a may be arranged with threads. The connection portion 3412a may be threadedly connected to the first connection sleeve 311a and the second connection sleeve 322a. For example, the wall for forming the through hole 319a may be arranged with threads, and the connection portion 3412a may be threadedly connected to the first connection sleeve 311a. For example, the connection portion 3412a may directly pass through the through hole 3221a and the through hole 319a to be detachably connected to other components.

For example, the control assembly 340a may further include a reinforcing member 343a. The reinforcing member 343a may be mounted on the first connection sleeve 311a. The first control member 341a may pass through the rotation member 320a to be detachably connected to the reinforcing member 343a. For example, the reinforcing member 343a may define a screw hole 3431a, and the connection portion 3412a may be mounted in the screw hole 3431a. The connection portion 3412a and the reinforcing member 343a may be threadedly connected to each other. For example, the screw hole 3431a may be defined in an end of the reinforcing member 343a.

For example, in order to reduce a weight of the first connection sleeve 311a, the leg protection bracket 310a may further include two third connection sleeves 313a. Each third connection sleeve 313a may be arranged inside a respective one first connection sleeve 311a, or the first connection sleeve 311a may be arranged to surround the third connection sleeve 311a. In order to increase stability between the first connection sleeve 311a and the third connection sleeve 311a, a plurality of reinforcing ribs 315a are connected between the first connection sleeve 311a and the third connection sleeve 311a. For example, the plurality of reinforcing ribs 315a may be spaced apart from each other and may be evenly distributed between the first connection sleeve 311a and the third connection sleeve 311a.

For example, the reinforcing member 343a may be mounted inside the third connection sleeve 313a.

For example, the reinforcing member 343a may be connected to the first connection sleeve 311a and the third connection sleeve 311a.

In the present disclosure, the leg protection bracket 310a may be connected to the bearing component 100a through two connection rods 350a. For example, the leg protection bracket 310a may be connected to the two connection rods 350a.

In order to ensure that the leg protection component 300a may be applicable to various users and the leg protection component 300a provides better protection effects, the leg protection component 300a in the present embodiment may further include two adjustment rods. The two adjustment rods 360a may be movably connected to the two connection rods 350a to adjust a distance between the leg protection bracket 310a and the bearing component 100a. One of the two adjustment rods 360a may be movably connected to a respective one of the two connection rods 350a.

For example, each of the two adjustment rods 360a may be hollow, such that weights thereof may be reduced, and one adjustment rod 360a and one connection rod 350a may be sleevedly connected to each other. For example, the connection rod 350a sleeves the adjustment rod 360a, or a part of the adjustment rod 360a may be inserted into the connection rod 350a. It can be understood that the adjustment rod 360a may alternatively sleeve the connection rod 350a. After the connection rod 350a and the adjustment rod 360a are sleevedly connected to each other, one or more adjustment assemblies 370a may be arranged to connect one adjustment rod 360a to one connection rod 350a. The one or more adjustment assemblies 370a may separate the one adjustment rod 360a apart from the one connection rod 350a, so as to achieve disassembling of the connection rod 350a and the adjustment rod 360a. It can be understood that the number of the one or more adjustment assemblies 370a in the present disclosure may be at least two, and the at least two adjustment assemblies 370a may connect the two adjustment rods 360a respectively to the two connection rods 350a.

Any adjustment rod 360a or any connection rod 350a defines a plurality of adjustment holes. For example, any adjustment rod 360a defines the plurality of adjustment holes 361a, and the plurality of adjustment holes 361a may be distributed in a row along an axis of the adjustment rod 360a to form a row of adjustment holes 361a. Any connection rod 350a defines one or two fourth connection holes 352a. After one adjustment rod 360a is inserted into one connection rod 350a, any fourth connection hole 352a may be communicated with and aligned to any adjustment hole 361a. The adjustment assembly 370a may be at least partially mounted in one adjustment hole 361a and communicated one fourth connection hole 352a to connect the adjustment rod 360a to the connection rod 350a.

For example, the adjustment assembly 370a may be referred to the movable assembly 220a, which will not be repeated here. For example, a pin 221a of the adjustment assembly 370a may be mounted in the fourth connection hole 352a and the adjustment hole 361a. A fastening structure 222a of the adjustment assembly 370a may sleeve the connection rod 350a.

In order to increase connection stability between the adjustment rod 360a and the connection rod 350a, the leg protection component 300a of the present embodiment may further include a stabilizing member 380a. The stabilizing member 380a may be referred to a stabilizing member 230a and will not be repeated here. The stabilizing member 380a may be inserted into the adjustment rod 360a and the connection rod 350a to increase the connection stability between the adjustment rod 360a and the connection rod 350a.

For example, the leg protection component 300a may further include two caps 302a. One of the two caps 302a sleeves an end of the connection rod 350a away from the bearing component 100a. The cap 302a has a through hole, and one adjustment rod 360a may pass through the through hole of the cap 302a. For example, the cap 302a and the connection rod 350a may be detachably connected to each other. The cap 302a may sleeve the connection rod 350a or may be removed from the connection rod 350a. In other embodiments, the cap 302a and the connection rod 350a are fixedly connected to each other. The cap 302a may be connected to the connection rod 350a via an adhesive layer, or the cap 302a may be welded to be fixed with the connection rod 350a. Alternatively, the cap 302a and the connection rod 350a may be configured as an integral and one-piece structure. For example, hardness of the adjustment rod 360a and the connection rod 350a may be greater than that of the cap 302a. For example, the adjustment rod 360a and the connection rod 350a may be made of metal, and the cap 302a may be made of plastic.

For example, the cap 302 may include a sleeve portion and a blocking portion. The blocking portion and the sleeve portion may be fixedly connected to each other. For example, the blocking portion and the sleeve portion may be configured as an integral and one-piece structure. The sleeve portion is sleevedly connected to the connection rod 350a, and the blocking portion is disposed at an outside of the end of the connection rod 350a. In some cases, the blocking portion may abut against the end of the connection rod 350a.

In the present disclosure, in order to simplify connection between the leg protection bracket 310a, the adjustment rod 360a, and the bearing body 110a, the control assembly 340a may fasten the rotation member 320a to the leg protection bracket 310a and control the rotation member 320a to rotate on the leg protection bracket 310a. Moreover, the control assembly 340a may connect the adjustment rod 360a with the leg protection bracket 310a. It should be noted that connection between the rotation member 320a and the leg protection bracket 310a may be separated from connection between the leg protection bracket 310a and the adjustment rod 360a. For example, a structure for achieving the connection between the rotation member 320a and the leg protection bracket 310a may be different from a structure for achieving connection between the leg protection bracket 310a and the adjustment rod 360a. For example, the leg protection bracket 310a may be directly connected to the two adjustment rods 360a, for example, the leg protection bracket 310a may be fixed to the two adjustment rods 360a by welding or by an adhesive layer. In some embodiments, the leg protection bracket 310a may be fixedly connected to the two adjustment rods 360a via other structural components. For example, a plurality of rivets may be arranged to fix the two adjustment rods 360a to the leg protection bracket 310a. It should be noted that the other structural components may have the same structure as the movable assembly 220a, a mounting assembly 240a, or a connection assembly 280a. Details of the above structures may be referred to description about the movable assembly 220a, the mounting assembly 240a, or the connection assembly 280a, which will not be repeated here.

For example, the two first connection sleeves 311a may be connected to the two adjustment rods 360a. For example, the control assembly 340a may further include a second control member 344a, and the second control member 344a may connect to one adjustment rod 360a with one first connection sleeve 311a.

For example, the two third connection sleeves 313a may be connected to the two adjustment rods 360a. For example, one of the two third connection sleeves 313a and one adjustment rod 360a may be sleevedly connected to each other. For example, one third connection sleeve 313a may sleeve a part of one adjustment rod 360a, or a part of the adjustment rod 360a may be inserted in one third connection sleeve 313a. For example, one second control member 344a may be connected to one adjustment rod 360a, one first connection sleeve 311a, and one third connection sleeve 313a.

For example, an end of any adjustment rod 360a away from the connection rod 350a may define a first control hole 362a. Any third connection sleeve 313a may define a second control hole 3131a. The adjustment rod 360a may be mounted inside the third connection sleeve 313a. The first control hole 362a and the second control hole 3131a may be communicated with each other. Any first connection sleeve 311a may define a third control hole 3115a, and no obstacle is disposed between the third control hole 3115a and the second control hole 3131a, that is, the third control hole 3115a and the second control hole 3131a may be communicated with each other through a space defined therebetween.

The second control member 344a may be mounted in the third control hole 3115a, the second control hole 3131a, and the first control hole 362a, so as to connect the adjustment rod 360a to the first connection sleeve 311a and the third connection sleeve 313a, such that connection between the adjustment rod 360a and the leg protection bracket 310a may be achieved.

For example, the second control member 344a may be detachably connected to the adjustment rod 360a, the first connection sleeve 311a, and the third connection sleeve 313a. For example, the second control member 344a may be referred to the movable assembly 220a, which will not be repeated here. For example, the second control member 344a may be referred to the mounting assembly 240a or the connection assembly 280a, which will not be repeated here. For example, the second control member 344a may include a screw. In the present disclosure, the second control member 344a may be removed from the third control hole 3115a, the second control hole 3131a, and the first control hole 362a, such that the adjustment rod 360a and the leg protection bracket 310a may be separated from each other.

In the present disclosure, in order to increase connection strength between the adjustment rod 360a and the leg protection bracket 310a, the reinforcing member 343a may be connected to the adjustment rod 360a, and the reinforcing member 343a may be connected to the end of the adjustment rod 360a away from the connection rod 350a. For example, at least part of the reinforcing member 343a may be mounted inside the adjustment rod 360a, and the screw hole 3431a of the reinforcing member 343a may be exposed.

For example, the second control member 344a may further be connected to the reinforcing member 343a. For example, the second control member 344a may define a fourth control hole 3432a, and the fourth control hole 3432a may be communicated with the first control hole 362a. The second control member 344a may be mounted in the third control hole 3115a, the second control hole 3131a, the first control hole 362a, and the fourth control hole 3432a, so as to achieve connection between the adjustment rod 360a and the leg protection bracket 310a. For example, the fourth control hole 3432a may be a screw hole, and the second control member 344a may be threadedly connected to the reinforcing member 343a.

For example, a part of the reinforcing member 343a may be inserted into the adjustment rod 360a, and another part of the reinforcing member 343a may be disposed outside the end of the adjustment rod 360a away from the connection rod 350a. A periphery of the reinforcing member 343a disposed outside the adjustment rod 360a may define a positioning slot 3433a. An inner wall of the third connection sleeve 313a may be arranged with a positioning block 3132a. The positioning block 3132a may be received in the positioning slot 3433a, so as to achieve positioning between the reinforcing member 343a and the leg protection bracket 310a and to increase connection stability of the leg protection bracket 310a connected to the reinforcing member 343a and the adjustment rod 360a.

For example, the reinforcing member 343a may further be inserted into the adjustment rod 360a. For example, the end of the adjustment rod 360a away from the connection rod 350a may define a positioning notch communicated to the positioning slot 3433a. The positioning notch is configured to leave a space for the positioning block 3132a, such that the positioning block 3132a may be received in the positioning slot 3433a through the positioning notch. For example, a shape of the positioning slot 3433a may match a shape of the positioning block 3132a.

For example, the leg protection component 300a may further include a plurality of first leg protection members 301a. For example, the leg protection component 300a may include three first leg protection members 301a. The three first leg protection members 301a may be disposed on a same side of the two rotation members 320a and the leg protection bracket 310a. Specifically, two of the three first leg protection members 301a may be disposed on one side of the two rotation members 320a, such as on an inner surface 3211a of the protection portion 321a of each rotation member 320a. For example, the inner surface 3211a of the protection portion 321a may be an arc surface. When one of the three first leg protection members 301a is mounted on the inner surface 3211a of the protection member 321a, the first leg protection member may protect the thigh of the user. The concave arc surface may be conveniently fit with the thigh of the user.

For example, a thickness of the protection portion 321a may be gradually increased from an end away from the second connection sleeve 322a to the other end connected to the second connection sleeve 322a. In other words, the thickness of the protection portion 321a may be gradually decreased from the end connected to the second connection sleeve 322a to the other end away from the second connection sleeve 322a. In this way, structural strength of the second connection sleeve 322a may be maintained to a certain extent. Furthermore, since the thickness of the protection portion 321a is larger at positions closer to the second connection sleeve 322a, the rotation member 320a may be less likely to be damaged during rotation.

One first leg protection member 301a may be arranged on a side of the leg protection bracket 310a. For example, one first leg protection member 301a may be arranged on a side of a bracket body 312a. When the leg is placed on the bearing pad 120a, the thigh may be attached properly to the three first leg protection members 301a. The first leg protection member 301a may be made of soft material, which may be referred to the bearing pad 120a, and not be repeated here. It can be understood that after the three first leg protection members 301a are mounted on the same side of the two rotation members 320a and the leg protection bracket 310a, the three first leg protection members 301a may form an arc shape, such that a contact area contacting with the thigh may be increased, improving protection performance.

For example, a side of the leg protection bracket 310a away from the first leg protection members 301a may be arranged with a handle 314a for the user to hold. In some cases, the user may hold the handle 314a by hand.

For example, the rotation member 320a may include a plurality of reinforcing ribs 325a.

For example, the protection portion 321a of the rotation member 320a may define a shaft hole 3213a, extending through an inner surface 3211a and an outer surface 3212a of the protection portion 321a.

In some embodiments, in order to increase stability of the two rotation members being connected to the two first connection sleeves, in the present embodiment, a limiting structure may be disposed between each of the two rotation members and the respective one of the two first connection sleeves for structural limitation, so as to increase stability of the two rotation members being limited to the two first connection sleeves. For example, any first connection sleeve may be arranged with a first limiting structure on a side away from the adjustment rod, and any rotation member is arranged with a second limiting structure on a side away from the control plate. The first limiting structure and the second limiting structure may limit each other to limit the two rotation members with respect to the two second connection sleeves. Specifically, the first limiting structure may include a plurality of first limiting strips and a plurality of first limiting grooves. Adjacent two of the plurality of first limiting strips may be spaced apart from each other by one of the plurality of first limiting grooves. The second limiting structure may include a plurality of second limiting strips and a plurality of second limiting grooves. Adjacent two of the plurality of second limiting strips may be spaced apart from each other by one of the plurality of second limiting grooves. Each of the plurality of first limiting strips may be received in a respective one of the plurality of second limiting grooves, and each of the plurality of second limiting strips may be received in a respective one of the plurality of first limiting grooves. In this way, mutual limitation of the first limiting structure and the second limiting structure may be achieved, the rotation portion may be limited from a plurality of directions. Therefore, the rotation portion may be stably connected to the leg protection bracket, preventing the rotation portion from loosening or shaking after being connected to the leg protection bracket.

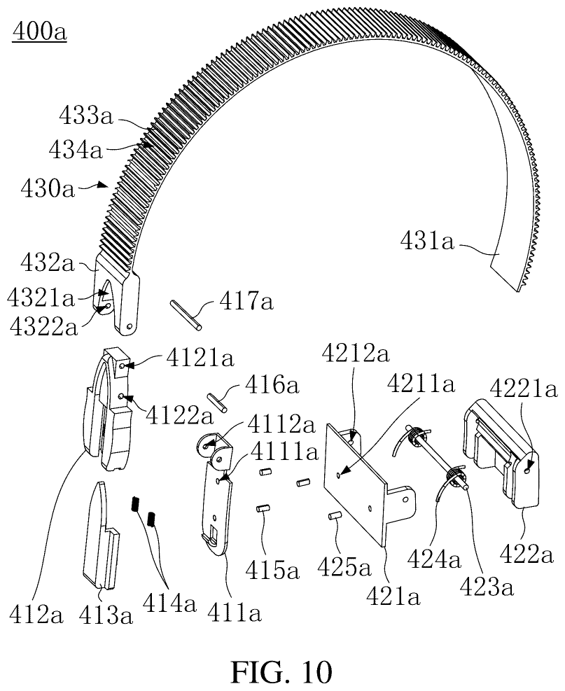

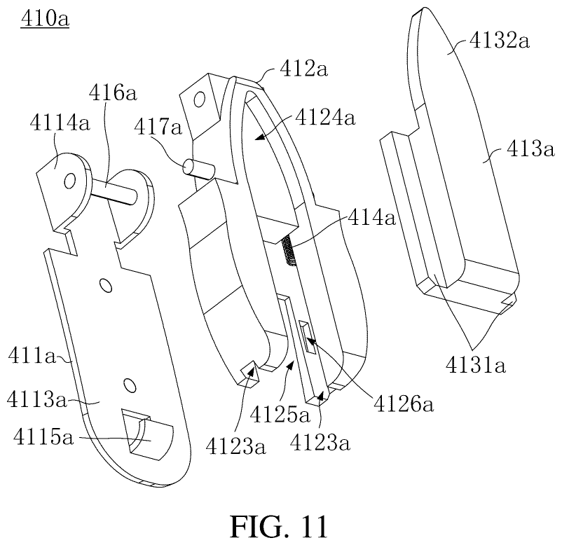

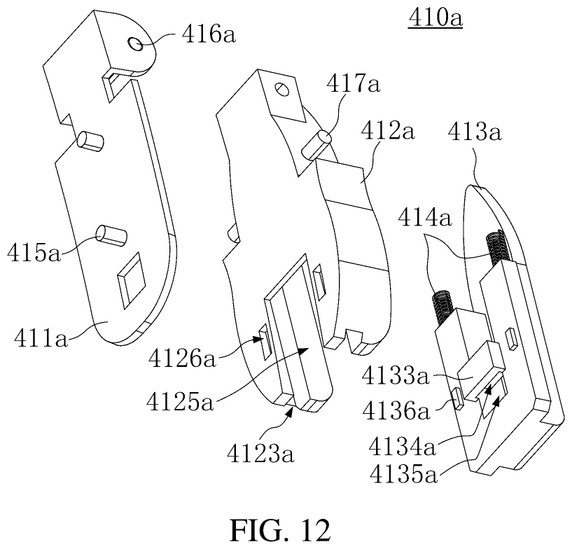

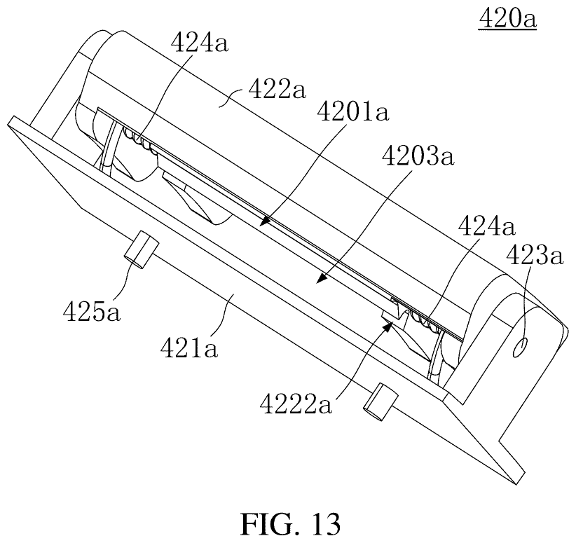

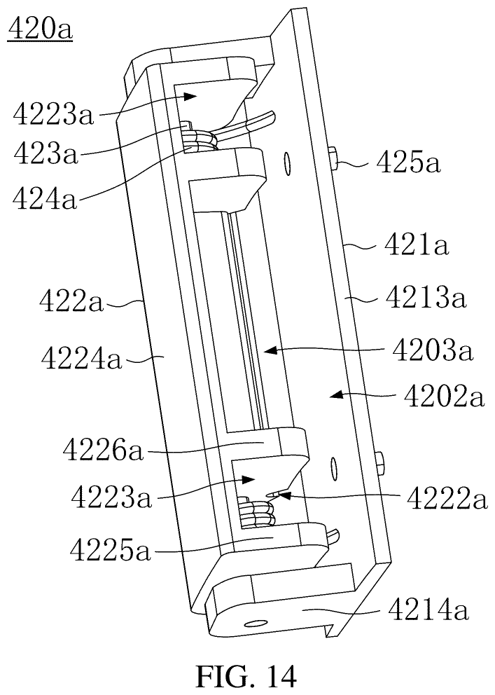

As shown in FIGS. 10 to 14, the hands-free crutch 10a may further include a plurality of binding components 400a, at least one of the plurality of binding components 400a may be connected to the two rotation members 320a, and at least another one of the plurality of binding components 400a may be connected to the bearing body 110a. The present disclosure will be described by taking three binding components 400a as an example. One of the three binding components 400a may be connected to the two rotation members 320a, and the other two of the three binding components 400a may be connected to the bearing 120a. It should be understood that the number of the plurality of binding components 400a is not limited in the present disclosure. It should be understood that connection positions of the plurality of binding components 400a are not limited in the present disclosure. For example, at least one of the plurality of binding components 400a may be connected to the leg protection bracket 310a.

For example, at least one of the three binding components 400a may include a binding belt 430a, a first binding structure 410a, and a second binding structure 420a. The binding belt 430a may be connected to the first binding structure 410a and the second binding structure 420a. For example, the first binding structure 410a and the second binding structure 420a may respectively be disposed on two sides of the bearing 110a. The first binding structure 410a and the second binding structure 420a may define the binding belt 430a to the bearing component 100a, such that the binding belt 430a, the first binding structure 410a, the second binding structure 420a, and the bearing component 100a cooperatively form a receiving space 12a. The calf of the user may be received in the receiving space 12a, and the binding belt 430a, the first binding structure 410a, the second binding structure 420a, and the bearing component 100a may cooperatively bind the thigh, facilitating the user to walk with the hands-free crutch 10a.

For example, the first binding structure 410a and the second binding structure 420a may be mounted on the two rotation members 320a. The first binding structure 410a and the second binding structure 420a may define the binding belt 430a to the leg protection component 300a, such that the binding belt 430a, the first binding structure 410a, the second binding structure 420a, and the leg protection component 300a cooperatively form a receiving space 11a. The thigh of the user may be received in the receiving space 11a. The binding belt 430a, the first binding structure 410a, the second binding structure 420a, and the leg protection component 300a cooperatively bind the thigh of the user, facilitating the user to walk with the hands-free crutch 10a.

For example, the binding belt 430a may be detachably connected to the first binding structure 410a and/or the second binding structure 420a, facilitating the hands-free crutch 10a to be conveniently transported and stored.

For example, the binding belt 430a being movably connected to the first binding structure 410a and/or the second binding structure 420a may be interpreted as a connection position where the binding belt 430a being connected to the first binding structure 410a and/or the second binding structure 420a being adjustable, so as to the connection position where the binding belt 430a is connected to the first binding structure 410a and the second binding structure 420a. In this way, ranges of the receiving spaces (11a, 12a) formed by the binding belt 430a, the first binding structure 410a, and the second binding structure 420a with the leg protection component 300a or the bearing component 100a may be adjusted.

For example, the first binding structure 410a may include a first fixation member 411a, a first fixation bracket 412a, and a first binding member 413a. The first fixation member 411a may be connected to the bearing 110a or the rotation member 320a. For example, the first fixation member 411a may define one or more shaft holes 4111a, such as two shaft holes 4111a. The bearing 110a may define a plurality of shaft holes 119a, and the first binding structure 410a may include two first shafts 415. The two first shafts 415 may be mounted respectively in the two shaft holes 4111a and two of the plurality of shaft holes 119a to mount the first fixation member 411a on the bearing body 110a. The two first shafts 415 may further be mounted respectively in the two shaft holes 4111a and two shaft holes 3213a to mount the first fixation member 411a on the rotation member 320a.

The first fixation member 411a may include a first fixation body 4113a and two first fixation plates 4114a disposed at an end of the first fixation body 4113a. The two first fixation plates 4114a may be spaced apart form each other. The two shaft holes 4111a extend through the first fixation body 4113a. The first fixation member 411a and the first fixation bracket 412a may be rotatably connected to each other. For example, the first fixation member 411a may further include two shaft holes 4112a respectively defined in the two first fixation plates 4114a. Each of the two shaft holes 4112a may be defined in a respective one of the two first fixation plates 4114a, and the two shaft holes 4112a may be opposite to each other. The first fixation bracket 412a may define a shaft hole 4121a, communicated with the shaft holes 4112a. The first binding structure 410a may further include a second shaft 416a, mounted in the two shaft holes 4112a and one shaft hole 4121a to connect the first fixation bracket 412a with the first fixation member 411a. The first fixation bracket 412a may rotate around the second shaft 416a relative to the first fixation member 411a.

A part of the first fixation bracket 412a may be disposed between the two first fixation plates 4114a, and the two first fixation plates 4114a may limit the part of the first fixation bracket 412a disposed therebetween.

The first fixation bracket 412a may be connected to the binding belt 430a. For example, the first fixation bracket 412a may define a shaft hole 4122a, and the binding belt 430a may include a belt body 431a and a fixation body 432a. The fixation body 432a may be connected to an end of the belt body 431a, for example, the fixation body 432a and the belt body 431a may be configured as an integral and one-piece structure. An end of the fixation body 432a away from the belt body 431a may define a notch 4321a, and the fixation body 432a may define two shaft holes 4322a, communicated with the notch 4321a. The two shaft holes 4322a may be communicated with the shaft hole 4122a.

For example, the first binding structure 410a may further include a third shaft 417a, mounted in the two shaft holes 4322a and the shaft hole 4122a to connect the fixation body 432a with the first fixation bracket 412a. The first fixation bracket 412a may rotate around the third shaft 417a relative to the fixation body 432a, in other words, the fixation body 432a may rotate around the third shaft 417a relative to the first fixation bracket 412a. Therefore, in the present disclosure, the fixation body 432a may rotate around the third shaft 417a relative to the first fixation bracket 412a, and the first fixation bracket 412a may rotate around the second shaft 416a relative to the first fixation member 411a. In this way, a distance between the fixation body 432a and the first fixation member 411a may be adjusted. Since the first fixation member 411a is mounted on the bearing body 110a, a distance between the fixation body 432a and the bearing body 110a may be adjusted.

The first binding member 413a may be mounted on the first fixation bracket 412a. For example, the first binding member 413a may be slidable on the first fixation bracket 412a. For example, the first fixation bracket 412a defines a first slide slot 4123a, and the first binding member 413a is arranged with a first slide portion 4131a. The first slide portion 4131a may be received in the first slide slot 4123a and may slide in the first slide slot 4123a. In order to increase sliding stability of the first binding member 413a on the first fixation bracket 412a, the first fixation bracket 412a may further define a second slide slot 4124a, and the first binding member 413a may be arranged with a second slide portion 4132a. The second slide portion 4132a may be received in the second slide slot 4124a and may slide in the second slide slot 4124a.

For example, the first fixation bracket 412a defines a slide hole 4126a, and the first binding member 413a is arranged with a third slide portion 4136a. The third slide portion 4136a may be received in the slide hole 4126a and may slide in the slide hole 4126a. For example, the slide hole 4126a may be communicated to the first slide slot 4123a, and the third slide portion 4136a may be disposed on a side of the first slide portion 4132a

The first binding member 413a may be connected to the first fixation member 411a to fix the first fixation bracket 412a to the first fixation member 411a. For example, the first fixation member 411a is arranged with a first buckle portion 4115a, and the first binding member 413a is arranged with a second buckle portion 4133a. The first buckle portion 4115a and the second buckle portion 4133a may be buckled with each other. For example, the first buckle portion 4115a may be a buckle structure, and the second buckle portion 4133a may include a buckle slot 4134a. The first buckle portion 4115a may be inserted into the buckle slot 4134a and may abut against the second buckle portion 4133a to achieve connection between the first fixation member 411a and the first binding member 413a. In order to facilitate the first buckle portion 4115a and the second buckle portion 4133a to be buckled with each other, the first binding member 413a defines an avoidance slot 4135a communicated to the buckle slot 4134a. The first buckle portion 4115a may be inserted into the buckle slot 4134a from the avoidance slot 4135a.

The first buckle portion 4115a and the second buckle portion 4133a may be separatable from each other, such that the first fixation bracket 412a and the first fixation member 411a may be connected to each other via the second shaft 416a.

In order to maintain the first buckle portion 4115a and the second buckle portion 4133a being buckled with each other, the first binding structure 410a may further include an elastic member 414a, received in the first slide slot 4123a and abutting against an end of the first slide portion 4131a near the second slide portion 4132a. The elastic member 414a may be elastically deformed and may be switched between an extended state and a compressed state. The elastic member 414a, when being in the compressed state, may generate an elastic force. When the first buckle portion 4115a and the second buckle portion 4133a are buckled with each other, the elastic member 414a may be in the extended state. When the first buckle portion 4115a and the second buckle portion 4133a are separated from each other, the elastic member 414a may be in the compressed state. When no external force is applied on the first binding member 413a, the elastic force generated by the elastic member 414a may drive the first binding member 413a to move on the first fixation bracket 412a to enable the first buckle portion 4115a and the second buckle portion 4133a to be buckled with each other.

For example, a side of the binding belt 430a facing the bearing component 100a or facing the leg protection component 300a may include a soft material, such as Oxford cloth.

For example, the first binding structure 410a and the second binding structure 420a may have a same configuration. In other embodiments, the first binding structure 410a and the second binding structure 420a may have different configurations.

For example, the second binding structure 420a may include a second fixation member 421a and a second binding member 422a. The second fixation member 421a may be connected to the bearing body 110a or the rotation member 320a. For example, the second fixation member 421a may define one or more shaft holes 4211a, such as two shaft holes 4211a. The second binding structure 420a may further include two fourth shafts 423a. The two fourth shafts 423a may be mounted in the two shaft holes 4211a and two respective shaft holes 119a to mount the second fixation member 421a on the bearing body 110a. The two fourth shafts 423a may further be mounted in the two shaft holes 4211a and two respective shaft holes 3213a to mount the second fixation member 421a on the rotation member 320a.

The second fixation member 421a may include a second fixation body 4213a and two second fixation plates 4114a respectively arranged at two ends of the second fixation body 4213a. The two shaft holes 4211a extend through the second fixation body 4213a. The second fixation member 421a and the second binding member 422a may be rotatably connected to each other. For example, the second fixation member 421a may further define two shaft holes 4212a respectively defined in the two second fixation plates 4214a. The two shaft holes 4212a may be opposite to each other. The second binding member 422a may define a shaft hole 4221a, communicated with the two shaft holes 4212a. The second binding structure 420a may further include a fifth shaft 425a, mounted in the shaft hole 4221a and the two shaft holes 4212a to connect the second fixation member 421a with the second binding member 422a. The second binding member 422a may rotate around the fifth shaft 425a relative to the second fixation member 421a.

After the second fixation member 421a and the second binding member 422a are connected to each other, a binding entrance 4201a, a binding exit 4202a, and a binding channel 4203a may be defined. The binding entrance 4201a, the binding channel 4203a, and the binding exit 4202a may be communicated with each other in sequence. An end of the belt body 431a of the binding belt 430a away from the fixation body 432a may be inserted, from the binding entrance 4201a, into the binding channel 4203a and the binding exit 4202a. In some cases, the end of the belt body 431a away from the fixation body 432a may extend out from the binding exit 4202a.

After the belt body 431a is inserted into the binding channel 4203a, the second binding structure 420a may limit movement of the belt body 431a. For example, the binding belt 430a may further include a plurality of toothed strips 433a, the plurality of toothed strips 433a may be arranged on a side of the belt body 431a away from the bearing body 110a or away from the rotation members 320a. The plurality of toothed strips 433a may be spaced apart from each other. A tooth slot 434a may be defined between every adjacent two toothed strips 433a of the plurality of toothed strips 433a. The second binding structure 420a may define a binding slot 4222a that can receive the toothed strips 433a. For example, the binding slot 4222a may be defined in a side of the second binding member 422a near the second fixation member 421a, and the binding slot 4222a may be communicated with the binding channel 4203a. When the belt body 431a is inserted into the binding channel 4203a from the binding entrance 4201a, the plurality of toothed strips 433a may be engaged in the binding slot 4222a. When no additional force is applied to drive the second binding member 422a, the second binding member 422a may limit the belt body 431a from moving from the binding exit 4202a to the binding entrance 4201a. Therefore, the second binding structure 320a can limit the belt body 431a, and binding of the thigh and the calf of the user may be achieved.

For example, in order to maintain the second binding member 422a in limiting the belt body 431a from moving from the binding exit 4202a to the binding entrance 4201a, the second binding structure 420a may further include an elastic member 424a, sleeving the fifth shaft 425a. An end of the elastic member 424a abuts against the side of the second binding member 422a near the second fixation member 421a, and the other end of the elastic member 424a abuts against the side of the second fixation member 421a near the second binding member 422a. The elastic member 424a may be elastically deformed and may be switched between an extended state and a compressed state. The elastic member 424a may generate an elastic force in the compressed state. When the toothed strips 433a are engaged in the binding slot 4222a, the elastic member 424a may be in the extended state. When the toothed strips 433a are not engaged in the binding slot 4222a, or when the toothed strips 433a are separated from the binding slot 4222a, the elastic member 424a may be in the compressed state. When no external force is applied on the second binding member 422a, the elastic force generated by the elastic member 424a may drive the second binding member 422a to move on the second fixation member 421a to enable the toothed strips 433a to be engaged in the binding slot 4222a.

For example, the second binding member 422a may include a binding body 4224a, two first limiting plates 4225a, and two second limiting plates 4226a. The two first limiting plates 4225a and the two second limiting plates 4226a are disposed on a side of the binding body 4224a near the second fixation member 421a. The two first limiting plates 4225a may be disposed respectively at two ends of the binding body 4224a, and one of the two first limiting plates 4225a and a respective one of the two second limiting plates 4226a may be adjacent to each other to define a limiting space 4223a. Two elastic members 424a may be arranged, and one of the two elastic members 424a may be limited in the limiting space 4223a.

In some embodiments, one end of the binding belt 430a may be directly mounted on the bearing body 110a or the rotation member 320a, and the binding belt 430a may be connected to the second binding structure 420a.

In some embodiments, the first binding structure 410a may be configured to have a same structure as the second binding structure 420a as described above.

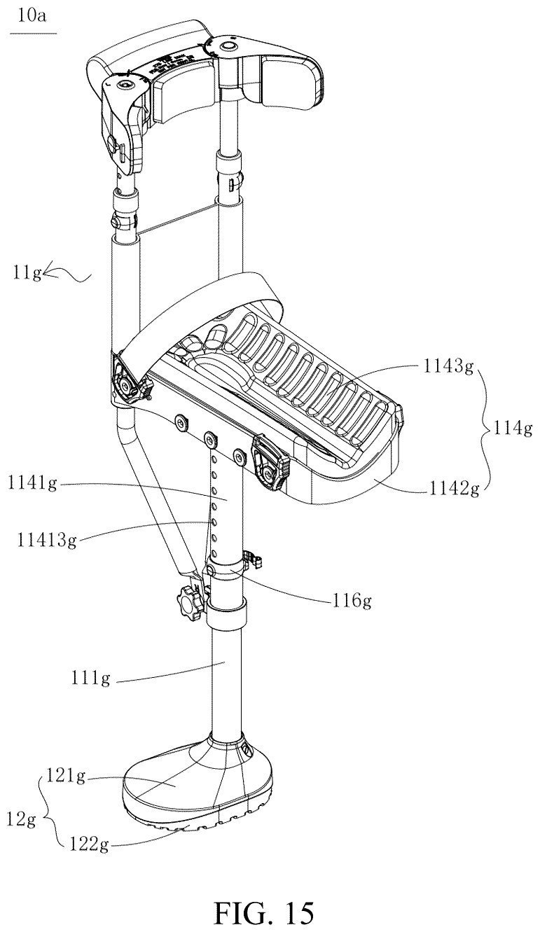

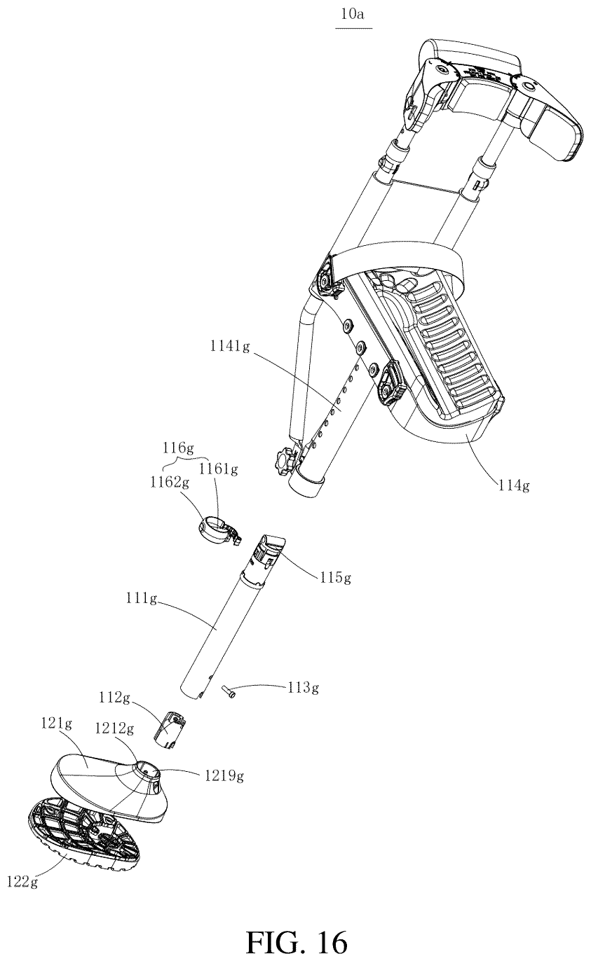

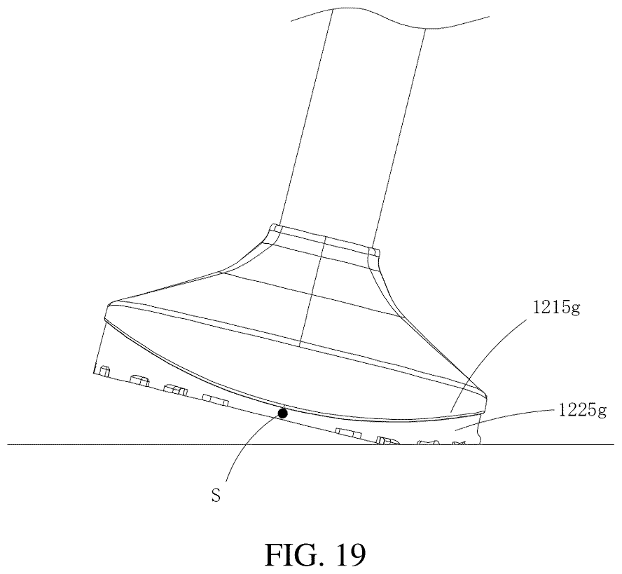

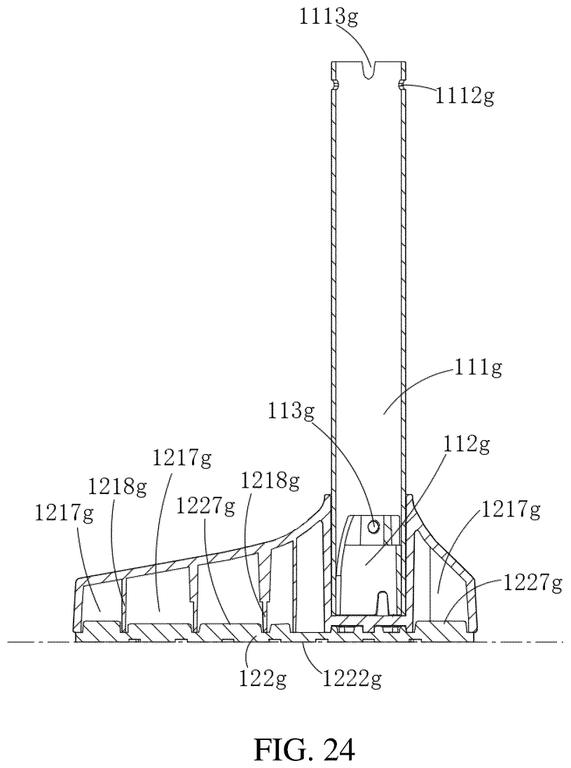

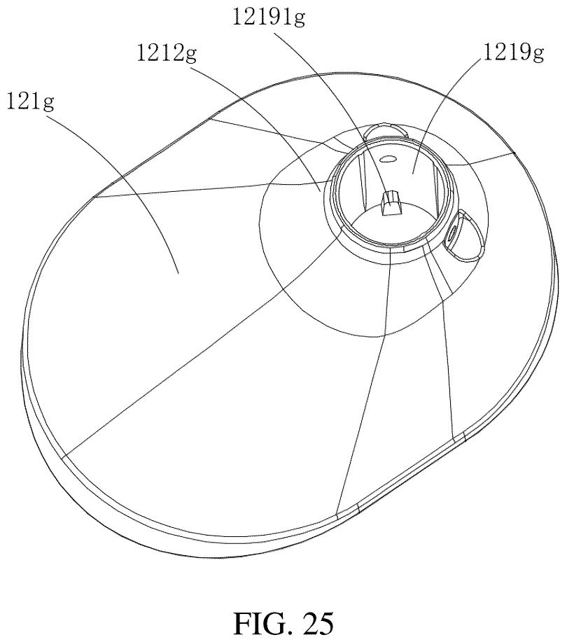

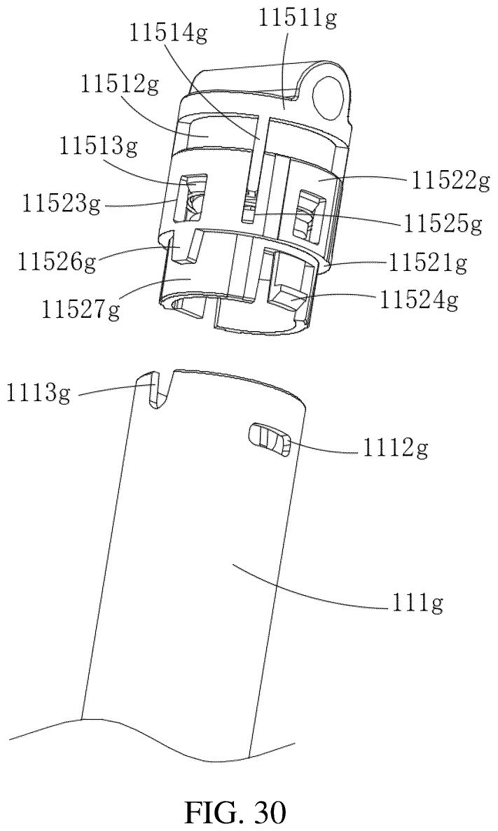

As shown in FIGS. 15 to 32, the hands-free crutch 10a in the present embodiment may further include a vibration reducing bracket 11g and a support foot 12g. The mounting bracket 11g is configured to be worn on the leg of the user, and the support foot 12g is configured to contact the ground. The support foot 12g may include a bottom shell 121g and a soft grounding member 122g. The bottom shell 121g is connected to the mounting bracket 11g, and the soft grounding member 122g is configured to contact the ground and provide buffering.

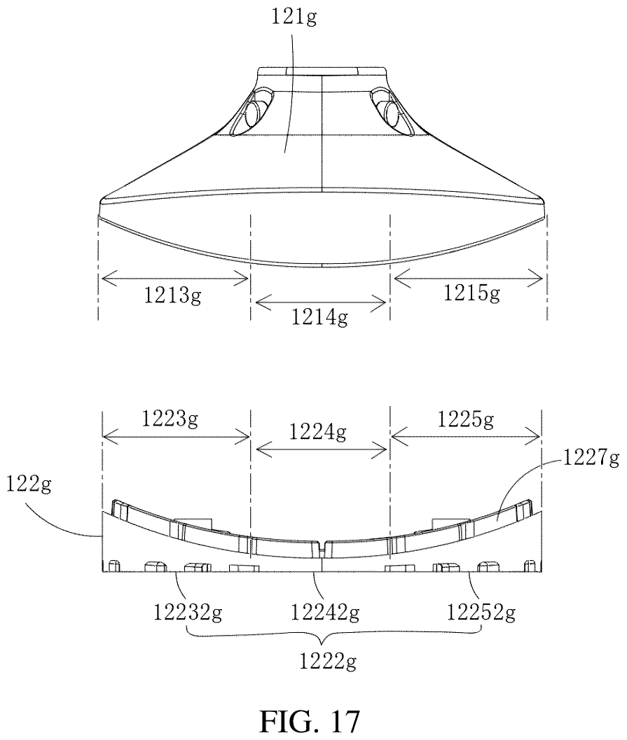

As shown in FIG. 17, a top 1212g of the bottom shell 121g may be connected to a bottom of the mounting bracket 1g, and a bottom 1211g of the bottom shell 121g may include a front section 1213g, a middle section 1214g, and a rear section 1215g. The front section 1213g and the rear section 1215g may both be disposed away from the ground, and the middle section 1214g may be disposed near the ground, such that the bottom shell 121g may be configured in an arc shape protruding towards the ground.

The soft grounding member 122g may include a first buffer section 1223g, a second buffer section 1224g, and a third buffer section 1225g. The first buffer section 1223g may be connected to the front section 1213g, the second buffer section 1224g may be connected to the middle section 1214g, and the third buffer section 1225g may be connected to the rear section 1215g.

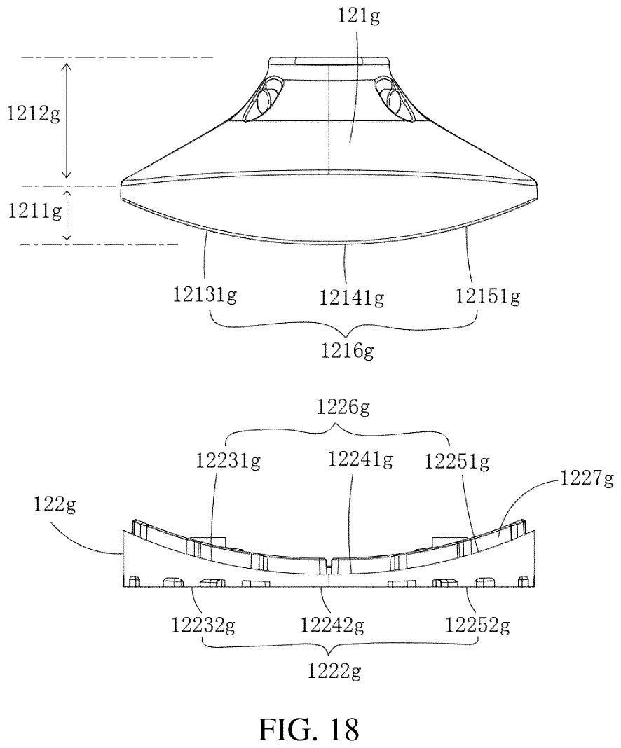

The soft grounding component 122g may be made of soft materials such as rubber and silicone. Each of a thickness of the first buffer section 1223g and a thickens of the third buffer section 1225g may be greater than that of the second buffer section 1224g. As shown in FIG. 18, a bottom surface 12232g of the first buffer section 1223g, a bottom surface 12242g of the second buffer section 1224g, and a bottom surface 12252g of the third buffer section 1225g may cooperatively form a horizontal contact surface 1222g, configured to contact the ground.

During the support foot 12g contacting the ground, the third buffer section 1225g provides buffering firstly. The thickness of the third buffer section 1225g is large, and therefore, a buffering stroke provided by the third buffer section 1225g may be long. In this way, before the soft grounding member 122g hits the ground, a height between a central portion S of the soft grounding member 122g and the ground may be reduced, and that is, a height that the soft grounding member 122g hits the ground may be reduced, and vibration generated after the support foot 12g contacts the ground may be reduced. As shown in FIG. 18, a state when the soft grounding member 122g is about to hit the ground is shown. It can be seen that, since the third buffer section 1225g is compressed, the height between the soft grounding member 122g and the ground is shortened, effectively reducing vibration caused by hitting.

After the soft grounding member 122g hits the ground, the first buffer section 1223g, the second buffer section 1224g, and the third buffer section 1225g cooperatively bear a pressure.

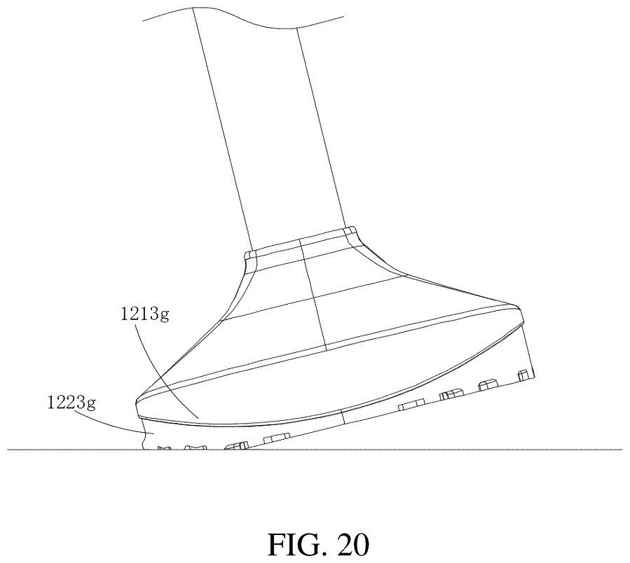

Subsequently, during a process of the support foot 12g leaving the ground, the first buffer section 1223g provides buffering. At this moment, the first buffer section 1223g bears a weight of the user, and the first buffer section 1223g may be compressed to generate an elastic potential energy to generate a forward elastic force on the support foot 12g. Since the thickness of the first buffer section 1223g is sufficient, a stronger pushing force is generated to assist the user in moving forward. As shown in FIG. 20, a state when the soft grounding member 122g is about to leave the ground is shown.

According to the above process, it can be seen that the hands-free crutch may be in more conformity with posture changes of real human foot during walking, and the user experience may be more comfortable.

Connection between the bottom shell 121g and the soft grounding member 122g is shown in FIG. 18, in the present embodiment, a bottom surface 12131g of the front section 1213g, a bottom surface 12141g of the middle section 1214g, and a bottom surface 12151g of the rear section 1215g are smoothly connected to each other to form a first curved connection surface 1216g. Atop surface 12231g of the first buffer section 1223g, a top surface 12241g of the second buffer section 1224g, and a top surface 12251g of the third buffer section 1225g are smoothly connected to each other to form a second curved connection surface 1226g. A curvature of the second curved connection surface 1226g is the same as that of the first curved connection surface 1216g, and the first curved connection surface 1216g and the second curved connection surface 1226g are attached to each other. The bottom shell 121g and the soft grounding member 122g may be connected to each other by one or more of: gluing, bolts, embedding, and so on. Each of the first curved connection surface and the second curved connection surface may be in the arc shape along a walking direction of the user, so as to simulate a moving trajectory of the real human foot during walking. The walking direction of the user may be the forward direction when the user walking with the hands-free crutch.

Specifically, the first curved connection surface 1216g may be configured in the arc shape to simulate the moving trajectory of the real human foot contacting the ground. The soft grounding connection 122g may be configured to enable a soft contact between the bottom shell 121g and the ground, preventing the support foot 12g from generating large vibration due to hard contact with the ground, and reducing vibration applied to the leg of the user.

After the user wears the hands-free crutch, since a contact surface 1222g is arranged horizontally extending, higher stability may be provided when the user standing upright.

When walking with the hands-free crutch, in a single step, the third buffer section 1225g, the second buffer section 1224g, and the first buffer section 1223g may provide buffering in sequence. In addition, hardness of the second buffer section 1224g may be greater than that of the first buffer section 1223g and that of the third buffer section 1225g.

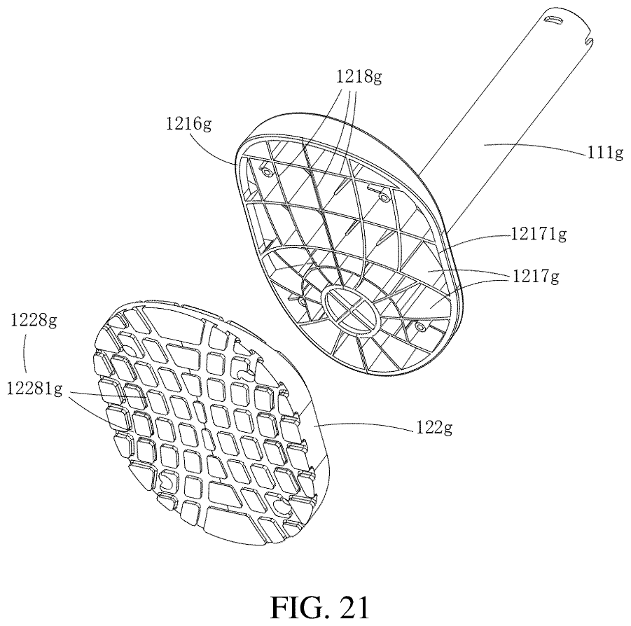

As shown in FIGS. 21, 22, and 24, in the preset embodiment, the bottom shell 121g and the soft grounding member 122g may be connected to each other by embedding and fixed to each other by bolts. Specifically, a plurality of embedding cavities 1217g may be defined inside the bottom shell 121g, and the plurality of embedding cavities 1217g have openings 12171g at the first curved connection surface 1216g. The soft grounding member 122g is arranged with a plurality of embedding protrusions 1227g on the second curved connection surface 1226g, and that is, the plurality of embedding protrusions 1227g may be disposed on the top surface 12231g of the first buffer section 1223g, the top surface 12241g of the second buffer section 1224g, and the top surface 12251g of the third buffer section 1225g. The plurality of embedding protrusions 1227g may be respectively inserted into the plurality of embedding cavities 1217g. The plurality of embedding protrusions 1227g may be configured to bear a tangential force between the bottom shell 121g and the soft grounding member 122g, preventing relative displacement between the soft grounding member 122g and the bottom shell 121g after the hands-free crutch being used for a long period of time, and that is, preventing unstable standing caused by the soft grounding member 122g slipping aside.

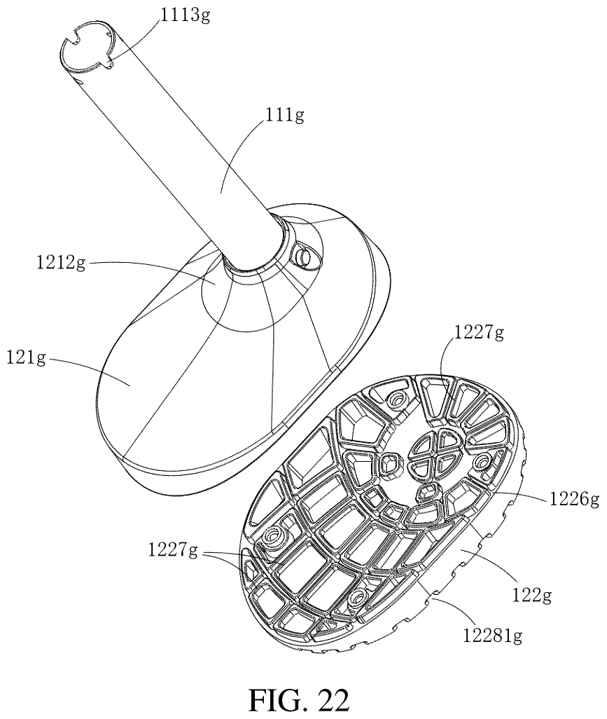

Further, while the soft grounding member 122g maintains having sufficient strength, in order to save material costs during production, in the present embodiment, at least one of the plurality of embedding protrusions 1227g may be arranged in a ring shape. In some embodiments, all of the plurality of embedding protrusions 1227g may be arranged in the ring shape. As shown in FIG. 22, that is, while a shape of each embedding protrusion 1227g is maintained, a material for a center of the embedding protrusion 1227g may be reduced.

In order to form the plurality of embedding cavities 1217g, in the present embodiment, the bottom shell 121g may be hollow, and a cavity 1210g may be formed inside the bottom shell 121g. A plurality of vertically extending partition plates 1218g may be arranged in the cavity 1210g. The plurality of partition plates 1218g may be arranged to cross with each other in the cavity 1210g. The plurality of partition plates 1218g may cooperatively divide the cavity 1210g to form the plurality of embedding cavities 1217g. Each of the plurality of embedding cavities 1217g corresponds, in shape, to a respective one of the plurality of embedding protrusions 1227g. After the plurality of embedding protrusions 1227g are respectively inserted into the plurality of embedding cavities 1217g, an outer side of each embedding protrusion 1227g may be tightly attached to an inner wall of the respective embedding cavity 1217g.

Further, an anti-slip structure 1228g may be arranged on the bottom surface 1222g of the soft grounding member 122g. The anti-slip structure 1228g may specifically be formed of a plurality of anti-slip protrusions 12281g. The anti-slip structure 1228g may be configured to increase roughness of the bottom surface 1222g of the soft grounding member 122g and prevent the soft grounding member 122g from slipping on the ground.

In addition, since the human foot is not straight forward during walking, but has a certain left and right offset, that is, a position of the foot being subjected to a force may be left and right offset to some extent. Therefore, in the present embodiment, the support foot 12g may be offset relative to the mounting bracket 11g. Specifically, the mounting bracket 11g may include a master support rod 11g, and a top 1212g of the bottom shell 121g may define an insertion slot 1219g. The master support rod 111g may be inserted into the insertion slot 1219g, and the insertion slot 1219g may be offset to a right along a length direction of the middle section 1214g relative to the center of the bottom shell 121g, as shown in FIGS. 15 and 22. In this way, the support foot 12g may be slightly offset to a left with respect to the state shown in the FIGS. 15 and 22. The user may flip the support foot 12g for 180° according to their own situation, and that is, the support foot 12g is adjusted to be offset to the right.

Further, regarding connection between the master support rod 111g and the support foot 12g, in the present embodiment, the master support rod 111g and the support foot 12g may be connected to each other via soldering, threads, magnetic attraction, snapping, and so on, which may not be unlimitedly listed herein. For example, in the present embodiment, the master support rod 11g may be hollow, and the mounting bracket 11g may further include a limiting ring 112g and a locking bolt 113g. The limiting ring 112g may be arranged inside the master support rod 11g; the locking bolt 113g extends through the bottom shell 121g from an outside of the bottom shell 121g and enters the insertion slot 1219g. Further, the locking bolt 113g may extend through the master support rod 111g and finally may be threaded into the limiting ring 112g. In this way, the master support rod 11g may be fixed in the insertion slot 1219g. According to the above configuration, the master support rod 111g may be produced easily.

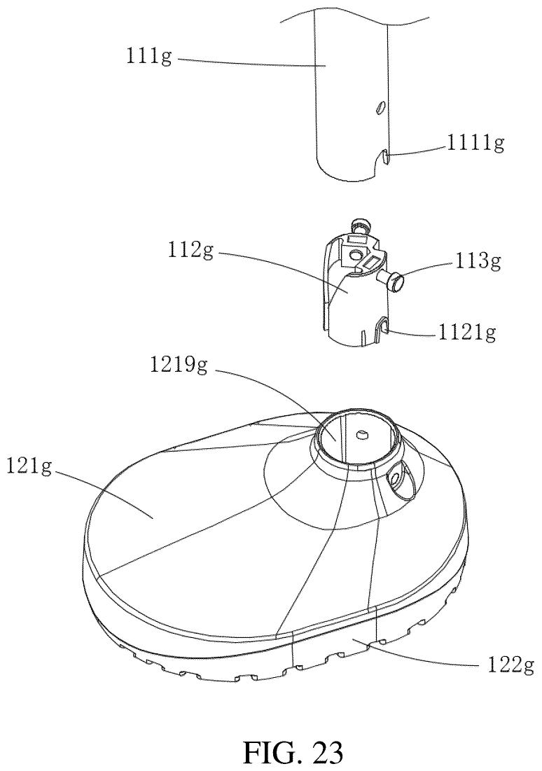

In order to accurately position the master support rod 111g and the support foot 12g and prevent the support foot 12g from deflecting, in the present embodiment, as shown in FIGS. 23 to 25, a first limiting protrusion 12191g extending towards a center of the insertion slot 1219g may be arranged on an inner wall of the insertion slot 1219g. A bottom of the master support rod 111g may define a first limiting notch 1111g, and a bottom of the limiting ring 112g may define a second limiting notch 1121g. The first limiting notch 1111g and the second limiting notch 1121g may be positionally corresponding to each other. The first limiting protrusion 12191g may pass through the first limiting notch 1111g and the second limiting notch 1121g in sequence, to prevent the master support rod 111g and the support foot 12g from rotating relative to each other.

In the present embodiment, the mounting bracket 11g may include a master support rod 11g, a bearing component 114g, and a vibration damping component 115g. The bearing component 114g may be configured to bear the calf and the knee. Specifically, the bearing component 114g may include a mounting rod 1141g and a bearing member 1142g. In some embodiments, the mounting rod 1141g may be independently configured from the bearing component 114g. While in use, the bearing member 1142g bears the calf and the knee of the user. The mounting rod 1141g may be mounted below the bearing member 114g by threads, insertion, welding, snapping, and so on, so as to connect the master support rod 111g with the bearing member 1142g. In the present embodiment, the mounting rod 1141g sleeves the master support rod 111g, and an axis of the mounting rod 1141g coincides with an axis of the master support rod 111g. In some embodiment, the master support rod 11g may sleeve an outside of the mounting rod 1141g, and the master support rod 111g and the mounting rod 1141g may be extendable and retractable with respect to each other. The calf of the user may be placed on the bearing member 1142g, the master support rod 111g replaces the calf and performs functions of the calf of the user, and the support foot 12g replaces the foot and performs functions of the foot of the user.

The vibration damping component 115g may be mounted on a top of the master support rod 111g and is connected to the mounting rod 1141. That is, the master support rod 111g and the mounting rod 1141g may be connected to each other via the vibration damping component 115g. When the weight of the user is applied to the bearing member 1142g, the mounting rod 1141g may be pressed down relative to the master support rod 111g, causing the vibration damping component 115g to be compressed to generate an upward elastic force. During this process, the vibration damping component 115g is configured to provide buffering and reduce vibration generated after the hands-free crutch contacts the ground.

Further, the vibration damping component 115g and the master support rod 111g may be mounted to each other by soldering, threads, magnetic connection, snapping, or other means, which may not be unlimitedly listed herein. Similarly, the vibration damping device 115g and the mounting rod 1141g may be mounted to each other by soldering, threads, magnetic connection, snapping, or other means, which may not be unlimitedly listed herein.

In the present embodiment, in order to facilitate detachment and replacement of the vibration damping component 115g, specifically, the vibration damping device 115g is connected to the master support rod 11g via a snap. The mounting frame 11g further includes a locking component 116g. The locking component 116g may be configured to lock or unlock the connection between the vibration damping component 115g and the mounting rod 1141g. Therefore, after the vibration damping component 115g is connected to the mounting rod 1141g, the locking component 116g is mounted on the mounting rod 1141g, and at the same time, the locking component 116g is connected to the vibration damping component 115g. In this way, a positional relationship between the vibration damping device 115g and the mounting rod 1141g may be locked.

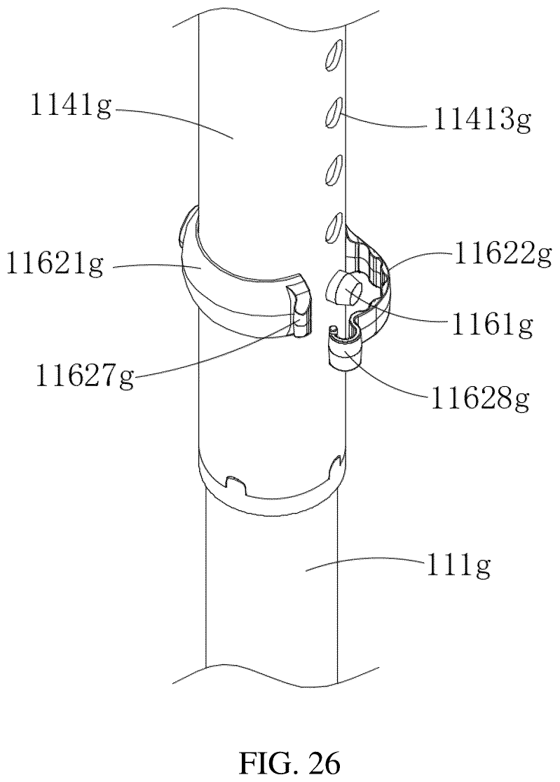

As shown in FIGS. 26 to 30, in regard to configurations of the vibration damping component 115g, in the present embodiment, specifically, the locking component 116g may include a positioning rod 1161g, and the positioning rod 1161g may extend through and may be mounted on the mounting rod 1141g. The vibration damping component 115g may include an upper mounting member 1151g, a lower mounting member 1152g, and an elastic member 1153g. The upper mounting member 1151g and the lower mounting member 1152g may be sleevedly connected to each other and may be slidable with respect to each other. The upper mounting member 1151g and the lower mounting member 1152g may move towards or away from each other. The positioning rod 1161g extends through the upper mounting member 1151g to connect the upper mounting member 1151g to the mounting rod 1141g. The lower mounting member 1152g may be mounted on the master support rod 111g, and the elastic member 1153g may be disposed between the upper mounting member 1151g and the lower mounting member 1152g and connect the upper mounting member 1151g with the lower mounting member 1152g.

The elastic member 1153g may be a compression spring. After the weight of the user is applied to the bearing member 1142g, the upper mounting member 1151g may move towards the lower mounting member 1152g, causing the compression spring to be compressed to generate an elastic force to provide vibration damping.

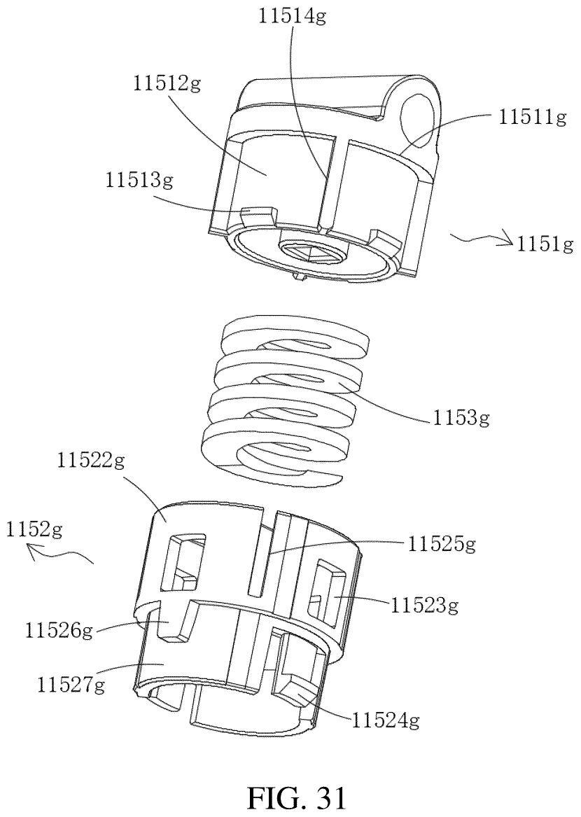

Further, as shown in FIG. 31, in regard to connection between the upper mounting member 1151g and the lower mounting member 1152g, in the present embodiment, the upper mounting member 1151g may include an upper abutting plate 11511g and an upper sleeve 11512g connected to a bottom of the upper abutting plate 11511g. The lower mounting member 1152g may include a lower abutting plate 11521g and a lower sleeve 11522g connected to a top of the lower abutting plate 11521g. The lower sleeve 11522g sleeves an outside of the upper sleeve 11512g, and the elastic member 1153g may be disposed inside the upper sleeve 11512g. An upper end of the elastic member 1153g may abut against the upper abutting plate 11511g, and a lower end of the elastic member 1153g may abut against the lower abutting plate 11521g. The positioning rod 1161g may extend through the upper abutting plate 11511g, and the lower abutting plate 11521g may be connected to the master support rod 111g.

In addition, an outer side of the upper sleeve 11512g may be arranged with a vertically extending guide protrusion 11514g, and the lower sleeve 11522g may define a vertically extending guide notch 11525g. The guide protrusion 11514g slides in the guide notch 11525g. The guide protrusion 11514g is configured to prevent relative rotation between the upper mounting member 1151g and the lower mounting member 1152g. Similarly, the lower abutting plate 11521g may be arranged with a second limiting protrusion 11526g and an insertion protrusion 11527g. The top of the master support rod 11g may define a third limiting notch 1113g. The second limiting protrusion 11526g may be received in the third limiting notch 1113g, to prevent relative rotation between the lower mounting member 1152g and the master support rod 111g. The lower abutting plate 11521g may abut against the top of the master support rod 111g, and the insertion protrusion 11527g may be inserted into the master support rod 111g.

Further, the upper mounting member 1151g may further include a first snap 11513g, connected to the outer side of the upper sleeve 11512g. The lower sleeve 11522g may be arranged with a vertically extending first snap slot 11523g, and the first snap 11513g may slide in the first snap slot 11523g. The first snap 11513g may be configured to prevent the upper sleeve 11512g from disengaging from the lower sleeve 11522g. In addition, the upper sleeve 11512g may be more easily mounted and disassemble based on snapping, such that any damaged component may be replaced easily.

Similarly, the lower abutting plate 11521g may abut against the top of the master support rod 11g, and the lower mounting member 1152g may further include a second snap 11524g, connected to a bottom of the lower abutting plate 11521g. The master support rod 111g may define a second snap slot 1112g, and the second snap 11524g may be snapped in the second snap slot 1112g. The lower mounting member 1152g may be further connected to the master support rod 111g by snapping. In this way, the vibration damping component 115g may be easily disassembled from the master support rod 111g.

Of course, in some embodiments, the upper sleeve 11512g may alternatively sleeve an outside the lower sleeve 11522g, the guide protrusion 11514g may be arranged on the lower sleeve 11522g, and the guide notch 11525g may be defined in the upper sleeve 11512g. This embodiment is not shown in the drawings.

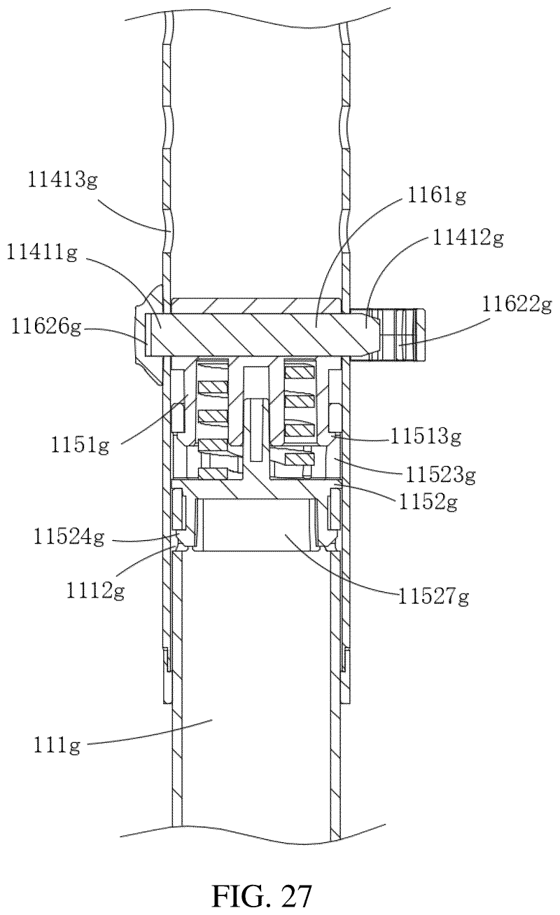

As shown in FIG. 27, in order to facilitate mounting and fixation of the locking component 116g, in the present embodiment, the positioning rod 1161g has a first end 11411g and a second end 11412g that are exposed from the mounting rod 1141g. The locking component 116g may further include a locking ring 1162g that sleeves the mounting rod 1141g and is connected to the first end 11411g and the second end 11412g.

During mounting, firstly, the vibration damping component 115g may be connected to the top of the master support rod 111g; and subsequently, the vibration damping component 115g may be inserted into the mounting rod 1141g. The positioning rod 1161g is used to extend through the mounting rod 1141g and the vibration damping component 115g, and subsequently, the locking ring 1162g is connected to the first end 11411g and the second end 11412g from the outside, so as to prevent the positioning rod 1161g from accidentally disengaging from the mounting rod 1141g and preventing the master support rod 111g from falling off.

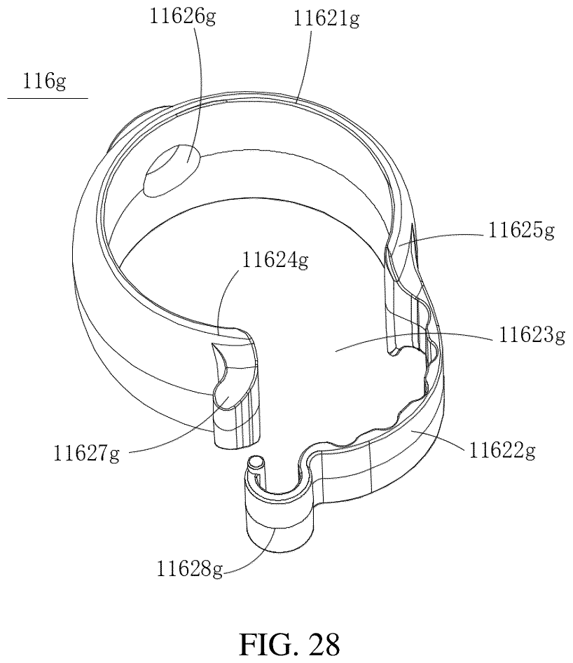

As shown in FIG. 28, in the present embodiment, the locking ring 1162g may include a ring body 11621g and a flexible locking belt 11622g. A side of the ring body 11621g may define a ring opening 11623g, and the ring body 11621g may include a third end 11624g and a fourth end 11625g that form the ring opening 11623g. The third end 11624g may be arranged with a locking hook 11627g, and the flexible locking belt 11622g may be connected to the fourth end 11625g. The flexible locking belt 11622g may be arranged with a hook 11628g hooked with the locking hook 11627g, and the hook 11628g may be hooked with or disengaged off from the locking hook 11627g. A side of the ring body 11621g opposite to the ring opening 11623g may define a fixation groove 11626g. A first end 11411g of the positioning rod 1161g may be inserted into the fixation groove 11626g, and when the hook 11628g is hooked with the locking hook 11627g, a second end 11412g may abut against the flexible locking belt 11622g. In this way, the positioning rod 1161g may be prevented from being disengaged off from the mounting rod 1141g. In addition, the flexible locking belt 11622g may be arranged with a rough surface to increase friction between the flexible locking belt 11622g and the positioning rod 1161g. After manually disengaging the hook 11628g from the locking hook 11627g, the positioning rod 1161g may be pulled out to disassemble the master support rod 111g from the mounting rod 1141g.

In order to enable the hands-free crutch to be adapted to users of various heights, in the present embodiment, a plurality of positioning holes 11413g may be defined along a length direction of the mounting rod 1141g, and the positioning rod 1161g may extend through any one of the plurality of positioning holes 11413g. According to the height of the user, a proper one of the plurality of positioning holes 11413g may be selected to allow the positioning rod 1161g to extend through.

Since the knee may protrude to some extent, in order to improve the user experience and prevent the knee of the user from being painful after long-term use, in the present embodiment, a top surface 11421g of the bearing member 1142g may be configured to be concave arc shaped to increase a contact area between the entire calf and the bearing member 1142g. The top surface 11421g of the bearing member 1142g may define a first groove 11422g at a position corresponding to the knee to increase a contact area between the knee and the bearing component 114g. That is, a force area of the knee may be increased, and a pressure applied to the knee may be reduced.

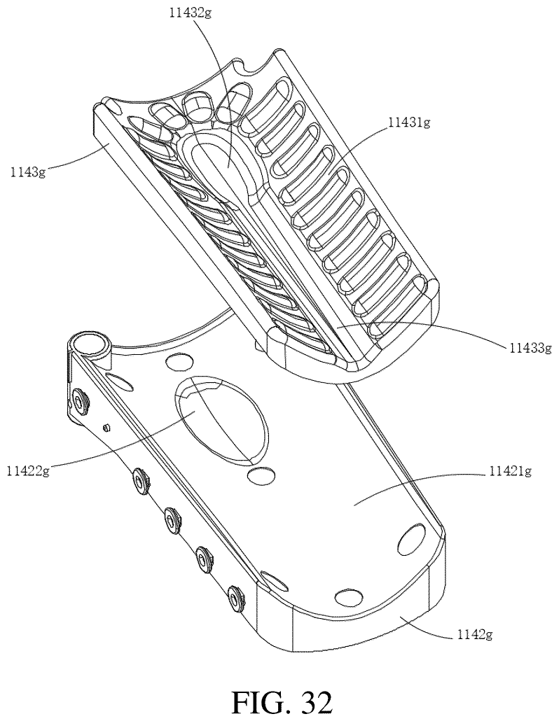

As shown in FIG. 32, the bearing component 114g may further include a soft buffer pad 1143g, mounted on the bearing member 1142g. The knee may be in soft contact with the bearing member 1142g through the soft buffer pad 1143g, improving usage comfortability. In addition, a top surface 11431g of the soft buffer pad 1143g may define a second groove 11432g corresponding to the first groove 11422g. The top surface 11431g of the soft buffer pad 1143g may further define a third groove 11433g extending along a length direction of the soft buffer pad 1143g. The third groove 11433g may be communicated with the second groove 11432g. The third groove 11433g may be configured to receive a tibia of the calf, increasing a force area of the calf at the tibia, and further improving the usage comfortability of the hands-free crutch.

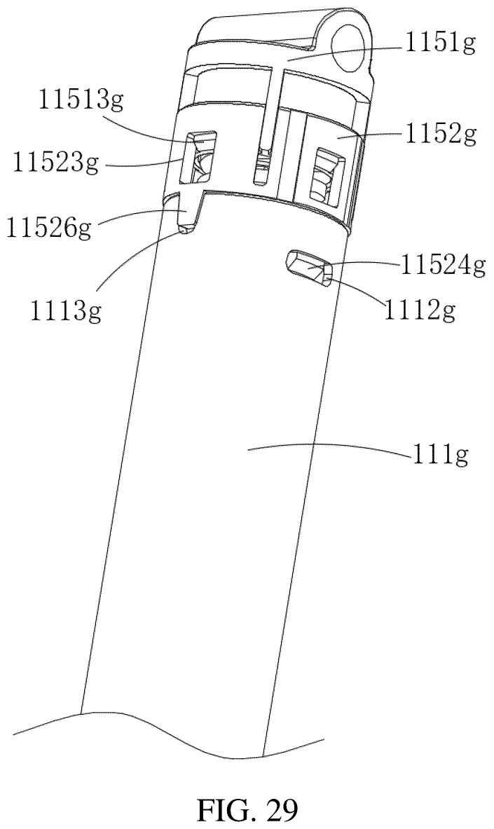

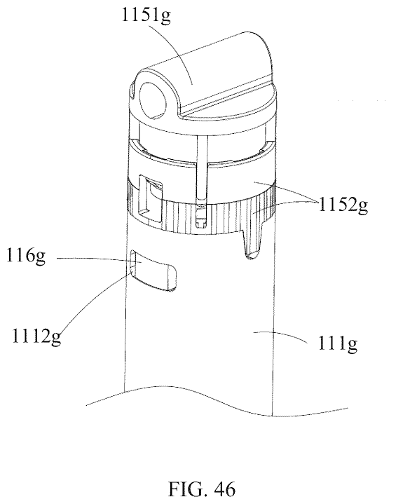

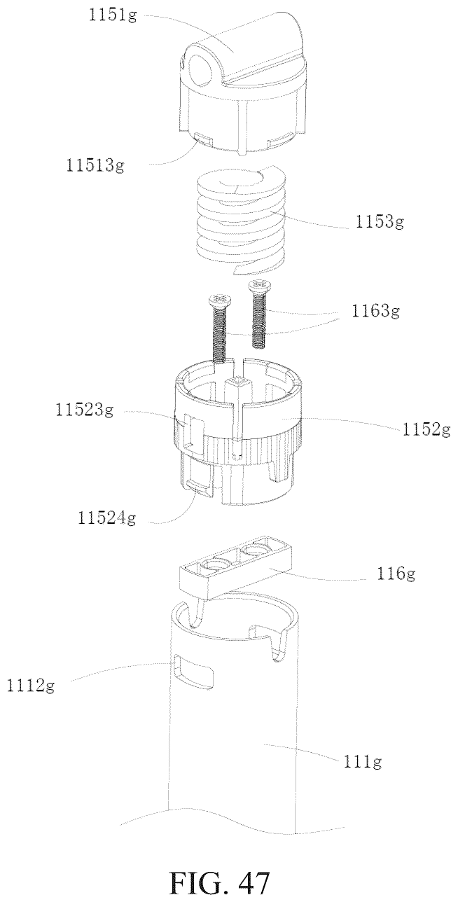

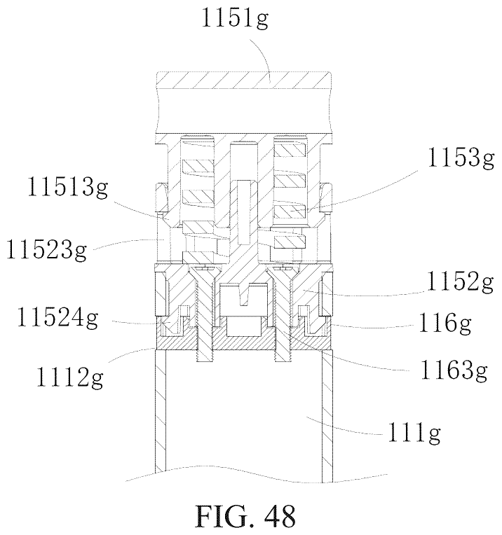

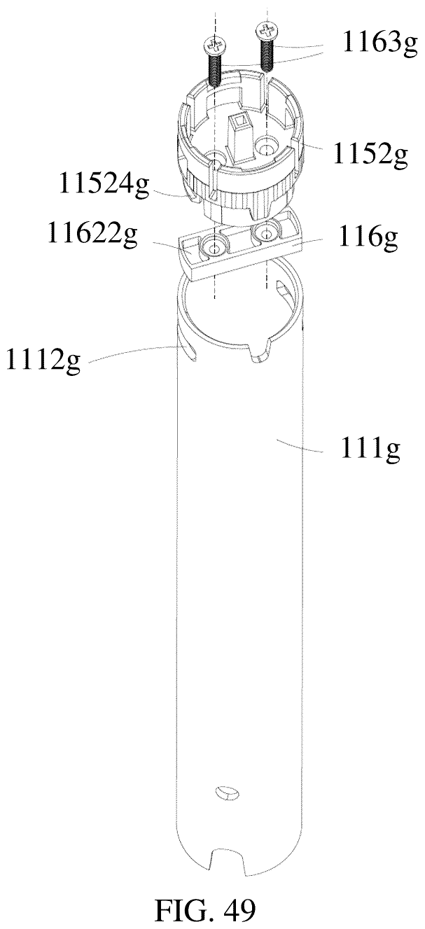

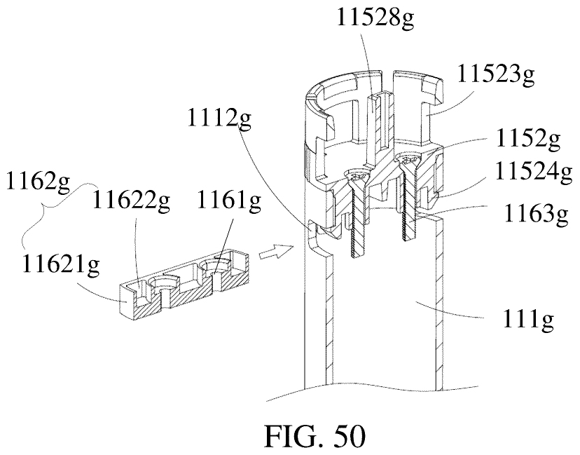

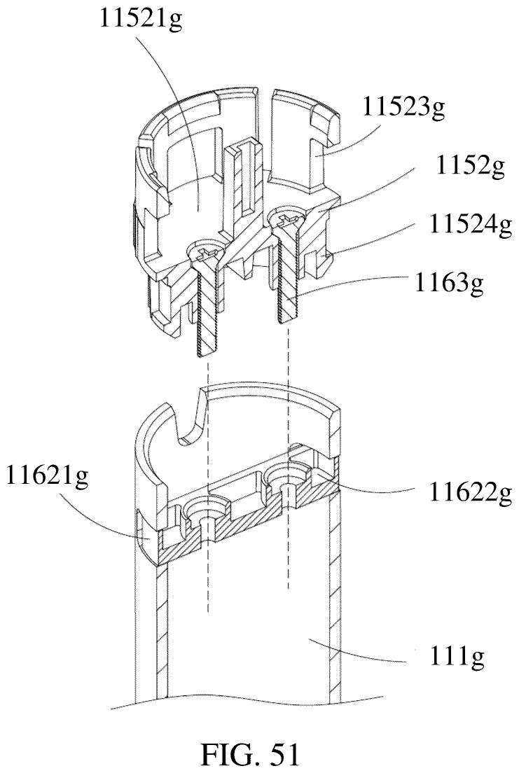

According to FIGS. 46-51, in an embodiment, in addition to the embodiment shown in FIGS. 29-31, in order to improve connection stability between the lower mounting member 1152g and the master support rod 111g, a fixation block 116g is arranged.

The fixation block 116g includes a fixation hole 1161g and a fixation portion 1162g.

The fixation block 116g is fixedly connected to the lower mounting member 1152g. Specifically, the lower mounting member further includes a connection post 11528g, extending from the lower abutting plate 11521g towards the upper mounting member 1151g. When the upper mounting member 1151g is sleevedly connected to the lower mounting member 1152g, the elastic member 1153g abuts between the upper mounting member 1151g and the lower mounting member 1152g and further sleeves the connection post 11528g, such that a compression direction of the elastic member 1152g is determined. The lower abutting plate 11521g defines a through hole. A connection member 1163g may be arranged to extend through the through hole in the lower abutting plate 11521g and the fixation block 116g, so as to fixedly connect the lower mounting member 1152g with the fixation block 116g. The connection member may be a screw, a pin, a bolt, or the like.

The connection portion 1162g includes an insertion portion 11621g and a receiving portion 11622g. The insertion portion 11621g is inserted into the second snap slot 1112g defined in the master support rod 111g. For example, an outer end surface of the insertion portion 11621g may be aligned with an outer surface of the master support rod 111g, and an inner surface of the insertion portion 11621g may be recessed from an inner surface of the master support rod 111g. The receiving portion 11622g may be a receiving recess, where a first portion of the receiving recess 11622g is located in the second snap slot 1112g, and a second portion of the receiving recess 11622g is located out of the second snap slot 1112g.

After the lower mounting member 1152g is fixedly connected to the fixation block 116g, the second snap 11524g is received in the receiving recess 11622g. A snap end of the second snap 11524g is exposed from a recess opening of the receiving recess 11622g and is located in the first portion of the receiving recess 11622g.

When the fixation block 116g, which is already connected with the lower mounting member 1152g, is connected to the master support rod 111g, the insertion portion 1162g is inserted into the second snap slot 1112g. Since the outer end surface of the insertion portion 11621g is aligned with an outer surface of the master support rod 111g but the inner surface of the insertion portion 11621g is recessed from the inner surface of the master support rod 111g, the first portion of the receiving recess 11622g is also located inside the second snap slot 1112g. Therefore, the snap end of the second snap 11524g, which is located in the first portion of the receiving recess 11622g, is received in the second snap 1112g, such that the snap end of the second snap 11524g can be snapped with the second snap slot 1112g.

In the present embodiment, connection between the lower mounting member 1152g and the master support rod 111g is achieved not only based on snapping between the second snap 11524g and the second snap slot 1112g. The fixation block 116g provides further secure for the connection therebetween. The lower mounting member 1152g is fixedly connected to the fixation block 116g, and the fixation block 116g is fixedly connected to the second snap slot 1112g in the master support rod 111g. Furthermore, the insertion portion 11621g does not occupy the entire second snap slot 1112g, but leaves a certain space of the second snap slot 1112g available to receive and to be snapped with the second snap 11524g. In this way, the connection between the lower mounting member 1152g and the master support rod 11g is more secure.

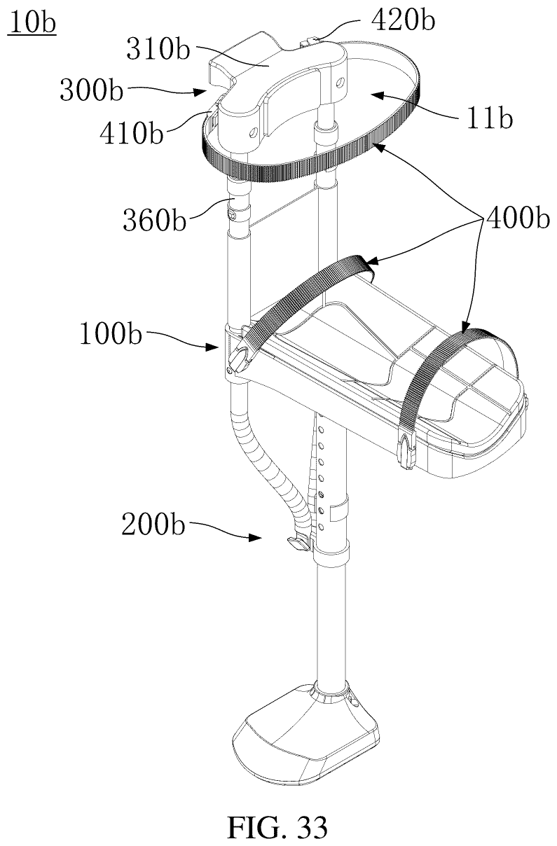

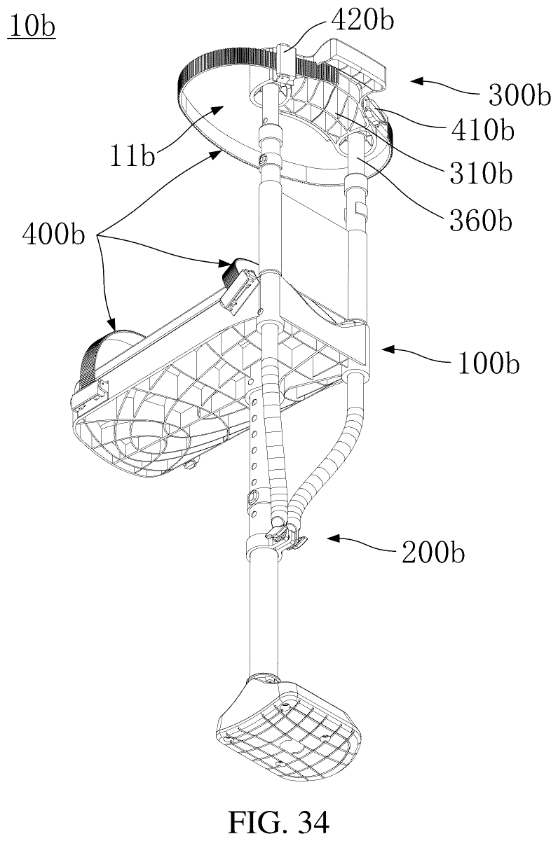

As shown in FIGS. 33 and 34, a hands-free crutch 10b is provided. For the hands-free crutch 10b, the leg protection component 300b of the hands-free crutch 10b may not include the rotation members 320a arranged in the leg protection component 300a of the hands-free crutch 10b. For example, the adjustment rod 360b of the leg protection component 300b may directly be mounted on the leg protection bracket 310a of the leg protection component 300b.

For example, one of the binding components 400b may directly be connected to the leg protection bracket 310b. For example, the first binding structure 410b and the second binding structure 420b of the binding component 400b may both be mounted on the leg protection bracket 310b. For example, the first binding structure 410b and the second binding structure 420b may be mounted respectively on two sides of the leg protection bracket 310b. The binding component 400b and the leg protection bracket 310b may directly form the receiving space 11b for receiving the thigh of the user.

The bearing component 100b, the support component 200b, and the binding component 400b of the hands-free crutch 10b may be referred to the bearing component 100a, the support component 200a, and the binding component 400a of the hands-free crutch 10a, which will not be repeated here.

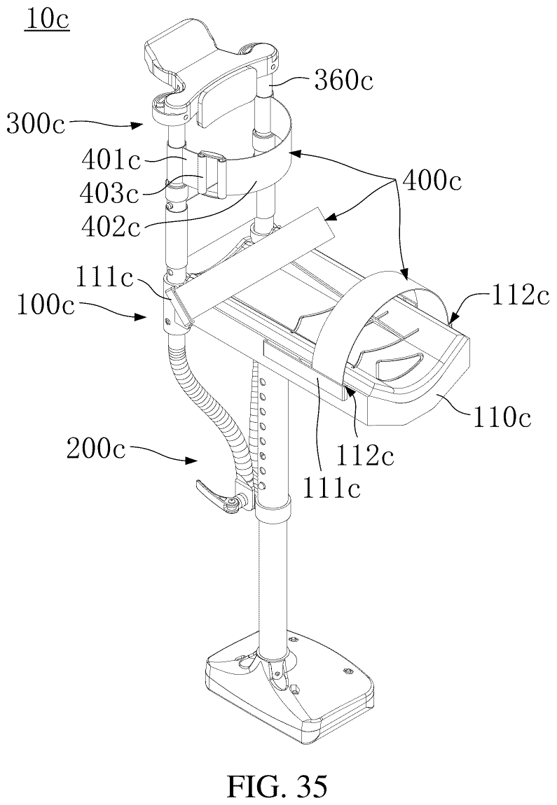

As shown in FIG. 35, a hands-free crutch 10c is provided. For the hands-free crutch 10c, the leg protection component 300c of the hands-free crutch 10c may not include the rotation members 320a of the leg protection component 300a of the hands-free crutch 10a. For example, the adjustment rod 360c of the leg protection component 300c may directly be mounted on the leg protection bracket 310c of the leg protection component 300c.

For the hands-free crutch 10c, the binding component 400c of the hands-free crutch 10c may include one or more strip-shaped binding belts, mounted on the bearing body 110c of the bearing component 100c and the adjustment rod 360c. For example, each of two sides of the bearing body 110c may be arranged with a plurality of binding portions 111c, and each of the plurality of binding portion 111c may define a binding hole 112c. The binding belt of the binding component 400c may pass through the binding hole 112c to be connected to the binding portions 111c. For example, the binding belt may be a female Velcro layer, and each of the two ends of the binding belt may be arranged with a male Velcro layer to be connected to the female Velcro layer. For example, the male Velcro layer may be connected to any position of the binding belt.

For example, three binding portions 111c and three binding holes 112c may be arranged on one side of the bearing body 110c. The bearing body 110c may be connected to one binding component 400c, two binding components 400c, or three binding components 400c. The user may determine the number of binding devices 400c and a desired binding position according to actual needs.

For example, one of the binding components 400c may be connected to the adjustment rod 360c. For example, each binding component 400c may include a first binding belt 401c, a second binding belt 402c, and a connection member 403c. The first binding belt 401c may be connected to one of the two adjustment rods 360c, and the second binding belt 402c may be connected to the other one of the two adjustment rods 360c. The first binding belt 401c and the second binding belt 402c may be connected to each other via the connection member 403c. For example, one of the first binding belt 401c and the second binding belt 402c may pass through the connection member 403c to be connected to each other via Velcro layers.

For example, in order to increase the usage comfortability of the binding component 400c being bound to the thigh and/or the calf, at least one of the plurality of binding components 400c may further include a leg protection sleeve, and the binding belt may pass through the leg protection sleeve. At least one side of the leg protection sleeve may be made of soft material, such as sponge, and breathable; and may be configured to be attached to the thigh and/or the calf.

In some embodiments, the first binding structure 410a of the binding component 400a may be connected to an end of the binding belt 430a, and the second binding structure 420a may be connected to the other end of the binding belt 430a. The first binding structure 410a and the second binding structure 420a may be connected respectively to two ends of the binding belt 430a. The binding component 400a may further include an adjustment assembly for adjusting the binding belt 430a. For example, the binding belt 430a may include two belt bodies, which are connected to each other through the adjustment assembly. The adjustment assembly may adjust a length of each of the two belt bodies to adapt to thighs or calves of various users. Alternatively, the adjustment assembly may adjust a size of the receiving space formed by the binding assembly 400a and the bearing component 100a or the leg protection assembly 300a.

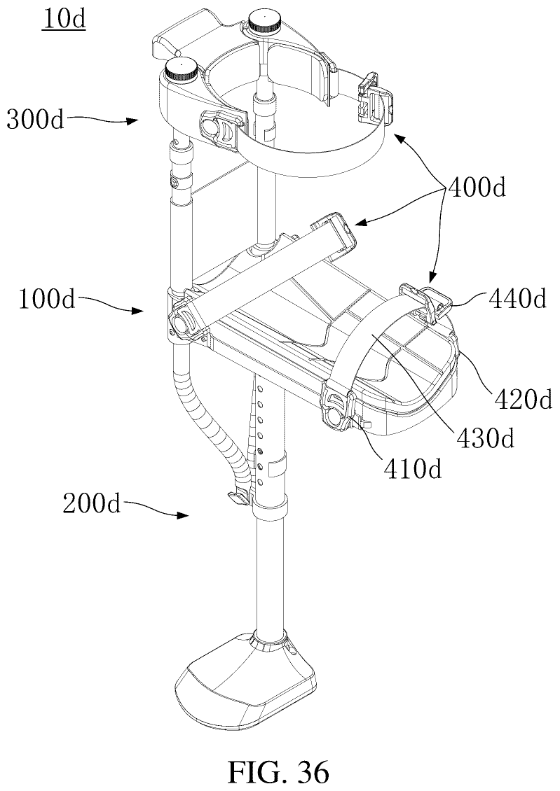

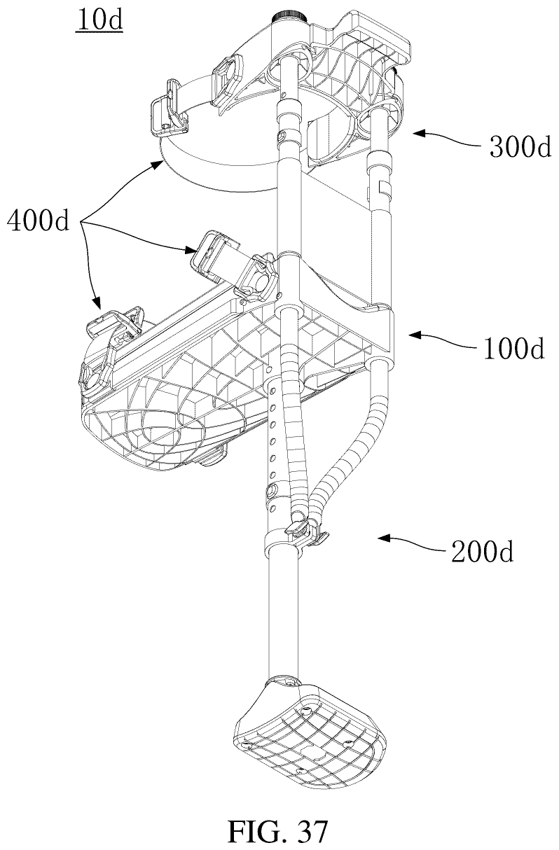

As shown in FIGS. 36 and 37, a hands-free crutch 10d is provided. For the hands-free crutch 10d, the binding component 400d may include a first binding structure 410d, a second binding structure 420d, and a binding belt 430d. The first binding structure 410d and the second binding structure 420d may both be detachably connected to the bearing component 100d or the leg protection component 300d. For example, the binding component 400d may further include an adjustment assembly 440d connected to the binding belt 430d. For example, the adjustment assembly 440d may be deformed to change the size of the receiving space formed by the binding component 400d and the bearing component 100d or the leg protection component 300d.

A support component 200d may be referred to the support component 200a, which will not be repeated here.

For example, the first binding structure may include a first binding ring, a first binding buckle, and a first positioning member. The first binding ring may be connected to an end of the binding belt. The first binding ring may form a first binding space, and the first binding buckle and the first binding member may be disposed in the first binding space. The first positioning member may be disposed closer to the binding belt than the first binding buckle is. For example, the first binding ring, the first binding buckle, and the first positioning member may be configured as an integral and one-piece structure.

For example, the second binding structure may include a second binding ring, a second binding buckle, and a second positioning member. The second binding ring may be connected to the other end of the binding belt. The second binding ring may form a second binding space, and the second binding buckle and the second binding member may be disposed in the second binding space. The second positioning member may be disposed closer to the binding belt than the second binding buckle is. For example, the second binding ring, the second binding buckle, and the second positioning member may be configured as an integral and one-piece structure.

For example, the first binding ring and the second binding ring may have a same shape, and the first binding buckle and the second binding buckle have a same shape.

For example, a first step may be arranged between the first binding block and the first binding ring, and a second step may be arranged between the second binding block and the second binding ring. A shape of the first step may be the same as that of the second step. A thickness of the first binding buckle may be less than a thickness of a position of the first binding buckle connected to the first binding ring, and a thickness of the second binding buckle may be less than a thickness of a position of the second binding buckle connected to the second binding ring.

For example, the first positioning member and the second positioning member may have a same shape. For example, each of the first positioning member and the second positioning member may include two elastic arms. Each of the two elastic arms may have an elastic section and an arc section. The arc section and the elastic section may be fixedly connected to each other, for example, the arc section and the elastic section may be configured as an integral and one-piece structure. The elastic section may be connected to the first binding ring and the second binding ring, and the elastic section may be disposed farther from the first binding buckle and the second binding buckle than the arc section is. The two elastic arms may be spaced apart from each other, and a distance between two elastic sections of the two elastic arms may be less than a distance between two arc sections of the two elastic arms. The distance between the two arc sections firstly gradually increases and then gradually decreases in a direction from an end away from the elastic section to approach the elastic section.

For example, the two rotation members may be arranged with a snap block and a snap plate on two sides away from the leg protection pad and the bearing body. In the present embodiment, the snap block and the snap plate on the bearing body will be taken as an example for description. The snap block may be connected to a side of the bearing body, and the snap block and the snap plate may be fixedly connected to each other, for example, the snap block and the snap plate may be configured as an integral and one-piece structure. The snap block may be disposed between the snap plate and the side of the bearing body, and an area of a cross section of the snap block may be smaller than that of the snap plate. At least part of a periphery of the snap block may define a continuous snap slot between the snap plate and the side of the bearing body. The snap slot may receive the first binding buckle or the second binding buckle, and a part of the snap plate may be arranged on the first binding buckle or the second binding buckle to limit the first binding buckle or the second binding buckle to the snap plate and the side of the bearing body. For example, the first binding buckle or the second binding buckle may be in interference-fit with the snap plate and the side of the bearing body. A free end of each of the first binding buckle and the second binding buckle may be arranged with a chamfer, facilitating the first binding buckle and the second binding buckle to be inserted into the snap slot.

When the first binding structure is mounted on the bearing body, the two elastic arms may be spaced from the snap plate.

For example, the snap plate may be cylindrical. A maximum distance between the two arc sections may be greater than a diameter of the snap plate, and a minimum distance between the two arc sections may be less than the diameter of the snap plate. The distance between the two elastic sections may be greater than the diameter of the snap plate. For example, a distance at the opening of the two arc sections may be greater than the distance between the two arc sections.

In the following, the first binding buckle being mounted on the side of the bearing body and being disassembled from the side of the bearing body will be described as an example for description.

During mounting the first binding structure, firstly, the snap plate may be disposed between the two elastic sections, and the two arc sections and the first binding buckle may be disposed on a same side of the snap plate and the snap block. Subsequently, the first binding structure may be driven to enable the first binding buckle to move towards the snap block and the snap plate, till the first binding buckle is inserted into the snap slot. During driving the first binding buckle of the first binding structure to move towards the snap block and the snap plate, an edge of the snap plate may firstly abut against the two arc sections, and subsequently, the snap plate may compress the two arc sections to cause the two arc sections and the two elastic sections to be deformed. In this way, the snap plate is released from limitation of the two arc sections to reach the first binding buckle. During snapping the first binding buckle into the snap slot, the snap plate may abut against the first binding buckle to allow the first binding buckle to be mounted on the side of the bearing body.

During disassembling the first binding structure, the first binding structure may be driven to enable the two elastic arms to move towards the snap plate and the snap block, till the first binding buckle is disengaged from the snap slot, and till abutment between the first binding buckle and the snap plate is released, and till the snap plate contacts the two arc sections. The first binding structure is further driven to enable the snap plate to compress the two arc sections, causing the two arc sections and the two elastic sections to be deformed, and the snap plate may enter the two elastic sections from the two arc sections. The distance between the two elastic sections may be greater than the diameter of the snap plate, such that the first binding structure may be detached off from a side of the bearing body. At this moment, the first binding structure may be removed.

In some embodiments, the first positioning member and the second positioning member may have different shapes. For example, the first positioning member may have two elastic arms, and detailed structures thereof may be referred to the above description, which will not be repeated here. The second positioning member may include at least one elastic arm and one moving arm. For example, two elastic arms may be arranged. The two elastic arms may be connected respectively to two ends of the moving arm, and the two elastic arms may be connected to the second binding ring. The two elastic arms and the moving arm may cooperatively form a moving space. The moving arm may be disposed closer to the second binding buckle than the elastic arm is.

During mounting the second binding structure, firstly, the snap plate may be placed in the moving space and below the moving arm, and the moving arm may abut against the snap plate. Further, the second binding ring may be pressed, causing the two elastic arms to be deformed elastically, till the second binding buckle is attached to the side of the bearing body. Subsequently, the second binding structure may be driven to move towards the snap block and the snap plate, till the second binding buckle is inserted into the snap slot. When the second binding buckle is inserted into the snap slot, the moving arm is separated from the snap plate, and the snap plate and the moving arm are spaced apart from each other, and the distance between the snap plate and the moving arm may be less than a predetermined distance, for example, the distance between the snap plate and the moving arm may be less than a length that the second binding buckle is inserted into the snap slot. In this way, the moving arm may limit the second binding buckle being inserted into the snap slot. For example, a side of the moving arm close to the snap plate may be arc-shaped and may match a shape of the snap plate.

During disassembling the second binding structure, firstly, the moving arm may be driven, based on the moving space, to move away from the side of the bearing body. For example, the user may insert a finger into the moving space, and the finger may hook the moving arm to make the elastic arms to be deformed, such that the moving arm may move towards the side of the bearing body, till the moving arm is disposed on the side of the snap plate away from the bearing body. Further, the second binding ring may be driven, for example, the moving arm may be driven to move towards the second binding buckle, to enable the moving arm to move to a surface of the snap plate. Subsequently, the second binding ring may be further driven to enable the second binding buckle to be disengage from the snap slot, and to enable abutment between the second binding buckle and the snap plate to be separated from each other. In this way, the second binding structure may be disassembled from the side of the bearing body.

It should be noted that in order to increase stability of the second binding structure being mounted on the bearing body, the side of the bearing body may be arranged with a blocking block. The blocking block may be placed in the moving space and may be spaced apart from the moving arm.

One of the three binding components may be connected to the two rotation members, and the one binding component may be configured to bind the thigh. The other two of the three binding components may be connected to the bearing body, and the two binding components may at least be configured to bind the calf In order to increase stability of the binding components binding the thigh and the calf, one of the two binding components connected to the bearing body may bind the calf, and the other one of the two binding components may bind a position between the thigh and the calf Specifically, the two snap blocks and the two snap plates may be disposed close to a front end of the bearing body and adjacent to the two second mounting sleeves. When the first binding structure and the second binding structure are connected to the front end of the bearing body, the first binding structure and the second binding structure may be inclined relative to the two second mounting sleeves, such that the binding belt may bind the position between the thigh and the calf.

It should be noted that in order to adapt to requirements of different users in binding different positions of the user body, two sides of the bearing body in the present disclosure may be arranged with two slide rails, and a sliding direction of each slide rail may be the length direction of the bearing body. The hands-free crutch may further include two moving members. The two moving members may be connected respectively to the two sides of the bearing body, and each of the two moving member may slide along a respective one of the two slide rails. Specifically, each moving member has a slide slot, and the respective slide rail is received in the slide slot. The moving member may slide along the slide rail. Each moving member may have a snap block and a snap plate, and a snap slot may be defined between the snap block and the snap plate. The snap block, the snap plate, and the snap slot may be referred to the above embodiments, which will not be repeated here. For example, the moving member may slide into the slide rail from a rear end of the bearing body.

In order to facilitate a size of the space defined by the binding belt to be adjusted, the binding component in the embodiment of the present disclosure may further include an adjustment assembly, connected to the binding belt to adjust the size of the space defined by the binding belt. For example, the binding belt may have a first belt body and a second belt body, and the first belt body and the second belt body may be connected to the adjustment assembly.

For example, the adjustment assembly may include a first adjustment member, a second adjustment member, a rotation shaft, and an elastic member. The rotation shaft may connect the first adjustment member to the second adjustment member, and at least one of the first adjustment member and the second adjustment member may rotate via the rotation shaft, to enable the first adjustment member and the second adjustment member to be rotatable relative to each other. The elastic member may include one or more torsion springs. An end of each torsion spring may be connected to the first adjustment member, and the other end of each torsion spring may be connected to the second adjustment member. The torsion spring may sleeve the rotation shaft.

The torsion spring may have a first state and a second state. The first state of the torsion spring may be treated as an initial state of the torsion spring. In the initial state, the torsion spring may drive an end of the first adjustment member away from the rotation shaft and an end of the second adjustment member away from the rotation shaft to move towards each other. The second state of the torsion spring may be treated as a state where the torsion spring is deformed under an external force. For example, the first belt body and the second belt body may be pulled respectively, such that a force is applied to the end of the first adjustment member away from the rotation shaft and the end of the second adjustment member away from the rotation shaft, enabling the end of the first adjustment member away from the rotation shaft and the end of the second adjustment member away from the rotation shaft to move away from each other. At the same time, the force is applied to the torsion spring, causing the torsion spring to be deformed. It can be understood that when the torsion spring is in the second state, the torsion spring may have an elastic force due to deformation. The elastic force of the torsion spring may be applied to the first adjustment member and the second adjustment member, such that the binding component may bind to the user more tightly.

It should be noted that a structure of the binding component and the number of binding components are not limited to the above examples. For example, four binding components may be arranged. One of the four binding components may be connected to two adjustment rods for binding the thigh. Another one of the four binding components may be connected to a position close to the front end of the bearing body. For example, the binding component connected to the bearing body may be connected to the bearing body and the second mounting sleeve for binding the thigh and the calf The other two binding components may be connected to the bearing body and connected between the front end and the rear end of the bearing body for binding the calf.

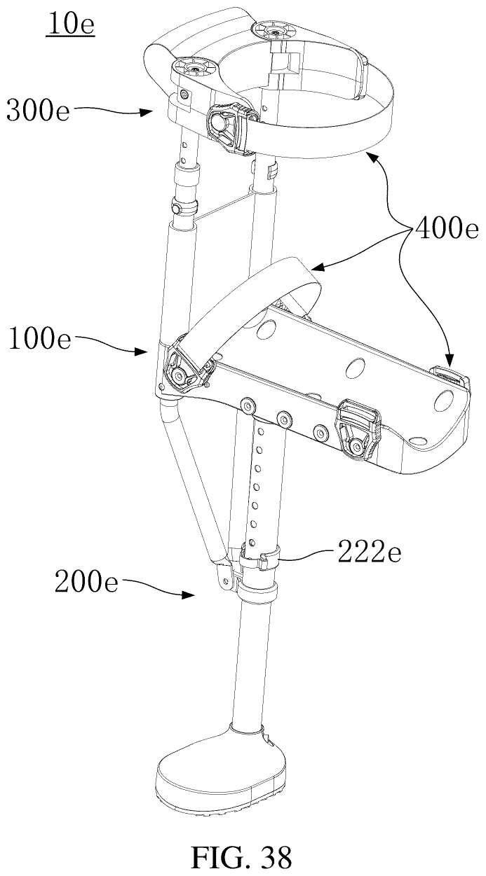

As shown in FIGS. 38 to 41, a hands-free crutch 10e is provided. For the hands-free crutch 10e, for example, each of the two rotation members 320e of the leg protection component 300e may include at least two rotation portions, and the at least two rotation portions may be connected to a same end of the leg protection member 321e. The at least two rotation portions may be rotatably connected to the leg protection bracket 310e. In the present embodiment, the rotation members 320e may be rotatably connected to the leg protection bracket 310a through the at least two rotation portions. Compared to the technical solution where the rotation member and the leg protection bracket are rotatably connected to each other via one rotation portion, the technical solution of the present embodiment may improve connection stability between the rotation members 320e and the leg protection bracket 310a and improve stability during rotation.

The present embodiment will be described by taking any rotation member 320e including a first rotation portion 322e and a second rotation portion 323e as an example. It should be noted that the rotation member 320e may include other numbers of rotation portions, such as three or four rotation portions, which will not be listed here.

Any adjacent two rotation portions may be spaced apart from each other. For example, the first rotation portion 322e and the second rotation portion 323e may be connected to the same end of the leg protection portion 321e, and the first rotation portion 322e and the second rotation portion 323e are separated by an interval space 325e. The rotation member 320e may further include a protection portion 321e. The first rotation portion 322e and the second rotation portion 323e may be connected to a same end of the protection portion 321e to cooperatively form the interval space 325e. For example, a thickness of the protection portion 321e gradually increases from an end away from the first rotation portion 322e and the second rotation portion 323e towards the end connected to the first rotation portion 322e and the second rotation portion 323e. For example, the protection portion 321e may define a plurality of weight reduction slots, and slot openings of the plurality of weight reduction slots of the protection portion 321e may be opened from the first rotation portion 322e towards the second rotation portion 323e.

In order to further reduce the weight of the rotation member 320e, at least one of the first rotation portion 322e and the second rotation portion 323e may define a plurality of weight reduction slots. For example, the first rotation portion 322e may define a plurality of weight reduction slots 3224e, and the second rotation portion 323e may define a plurality of weight reduction slots 3233e. Slot openings of the plurality of weight reduction slots 3224e of the first rotation portion 322e face opposite to slot openings of the plurality of weight reduction slots 3233e of the second rotation portion 323e. The slot openings of the plurality of weight reduction slots 3233e of the second rotation portion 323e face a same direction as the slot openings of the plurality of weight reduction slots of the protection portion 321e.

A part of the leg protection bracket 310e may be disposed between the first rotation portion 322e and the second rotation portion 323e to separate the first rotation portion 322e apart from the second rotation portion 323e. For example, the leg protection bracket 310e may include a bracket body 312e and two sleeve portions 311e. The two sleeve portions 311e may be connected respectively to two opposite sides of the bracket body 312e, and a stepped structure may be formed by any sleeve portion 311e and a respective one of the two sides of the bracket body 312e.

The two rotation portions 320e may respectively be connected to the two sleeve portions 311e. The first rotation portion 322e and the second rotation portion 323e of one rotation member 320e may be connected respectively to an upper side and a lower side of a respective one of the two sleeve portions 311e. That is, one sleeve portion 311e may be received in the interval space 325e. For example, the first rotation portion 322e may be disposed on a side of the sleeve portion 311e away from the bearing component 100e of the hands-free crutch 10e, and the second rotation portion 323e may be disposed on a side of the sleeve portion 311e near the bearing component 100e.

The two rotation portions 320e, the two sleeve portions 311e, and the two adjustment rods 360e of the leg protection component 300e may be connected via two control assemblies 340e. For example, the control assembly 340e may include a first control member 341e, a reinforcing member 343e, and a second control member 344e. The reinforcing member 343e may be inserted into the adjustment rod 360e, the sleeve portion 311e, the first rotation portion 322e, and the second rotation portion 323e. The first control member 341e may pass through the first rotation portion 322e and be connected to the reinforcing member 343e; and the second control member 344e may pass through the sleeve portion 311e and the adjustment rod 360 and be connected to the reinforcing member 343e. For example, each of the first control rotation portion 341e and the second control rotation portion 344e may be a screw or a bolt.

In some embodiments, the control assembly 340e may further include a gasket 342e. The first control member 341e may extends through gasket 342e. During the first control member 341e and the reinforcing member 343e being fastened to each other, a part of the first control member 341e may compress the gasket 342e, enabling the gasket 342e to be tightly attached to the first rotation portion 322e.

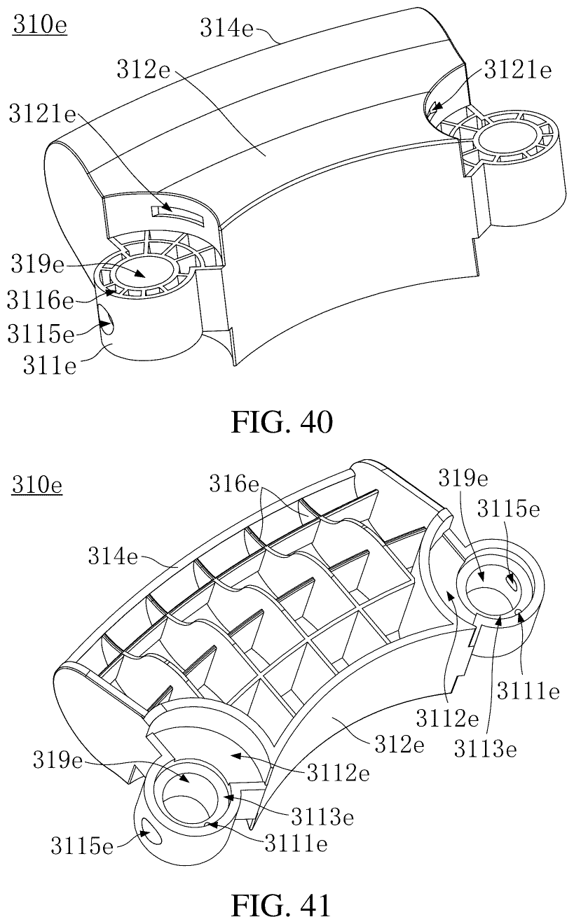

As shown in FIGS. 40 and 41, the sleeve portion 311e may include a third control hole 3115e and a through hole 319e communicated with the third control hole 3115e.

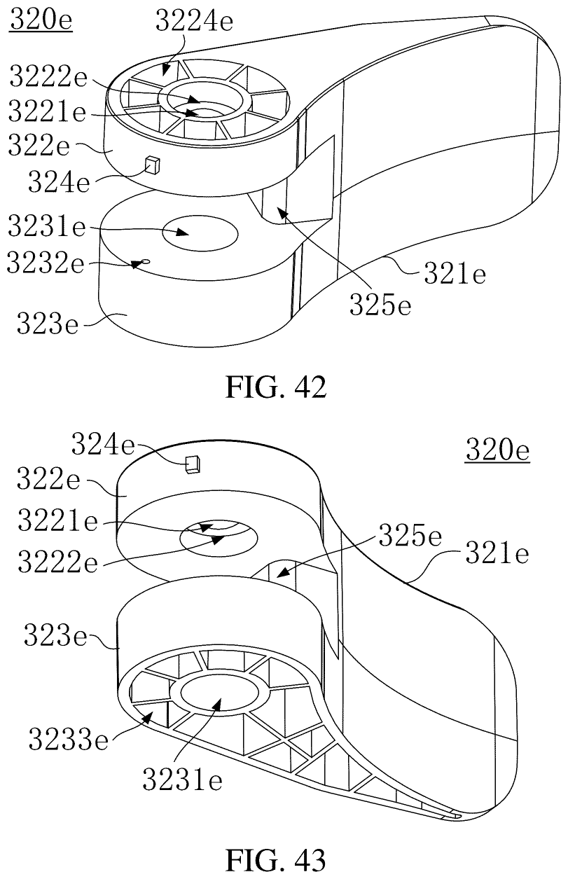

As shown in FIGS. 42 and 43, the second rotation portion 323e may include a rotation hole 3231e, and the first rotation portion 322e may include a rotation hole 3221e and a mounting slot 3222e communicated with the rotation hole 3221e. The mounting slot 3222e may be defined in a side of the first rotation portion 322e away from the second rotation portion 323e.

As shown in FIG. 45, the reinforcing member 343e may include a first insertion portion 3436e and a second insertion portion 3437e. The second insertion portion 3437e may be arranged on an end surface of the first insertion portion 3436e. For example, a diameter of the second insertion portion 3437e may be smaller than that of the first insertion portion 3436e. At least part of the first insertion portion 3436e may be inserted into the adjustment rod 360e, and the first insertion portion 3436e and a part of the adjustment rod 360e in which the first insertion portion 3436e is inserted may both be inserted into the rotation hole 3231e and the through hole 319e. At least a part of the second insertion portion 3437e may be inserted into the rotation hole 3221e.

The reinforcing member 343e may further include a screw hole 3431e and a screw hole 3432e. The screw hole 3431e may be defined in the second insertion portion 3431e, or the screw hole 3431e may be defined in the second insertion portion 3437e and the first insertion portion 3436e. The screw hole 3432e may be defined in the first insertion portion 3436e. The first control member 341e may pass through the rotation hole 3221e to be mounted in the screw hole 3431e, and the second control member 344e may pass through the third control hole 3115e and the first control hole of the adjustment rod 360e in sequence to be mounted in the screw hole 3432e. The first control hole of the adjustment rod 360e may be referred to the first control hole 362a, which will not be repeated here.

A part of the first control member 341a and the gasket 342e may be received in the mounting slot 3222e.

In the present embodiment, the part of the reinforcing member 343e inserted into the adjustment rod 360e may be wrapped by the second rotation portion 323e and the sleeve portion 311e. In the present embodiment, the reinforcing member 343e may further be inserted into the second rotation portion 323e and the sleeve portion 311e.

In order to increase stability of the first insertion portion 3436 inserted into the adjustment rod 360e, a periphery of the first insertion portion 3436e may be arranged with a plurality of protrusions 3435e that are spaced apart from each other. A thickness of each protrusion 3435e gradually increases along a direction extending from an end of the first insertion portion 3436e away from the second insertion portion 3437e towards an end near the second insertion portion 3437e. For example, the plurality of protrusions 3435e may be spaced apart at an equal interval.

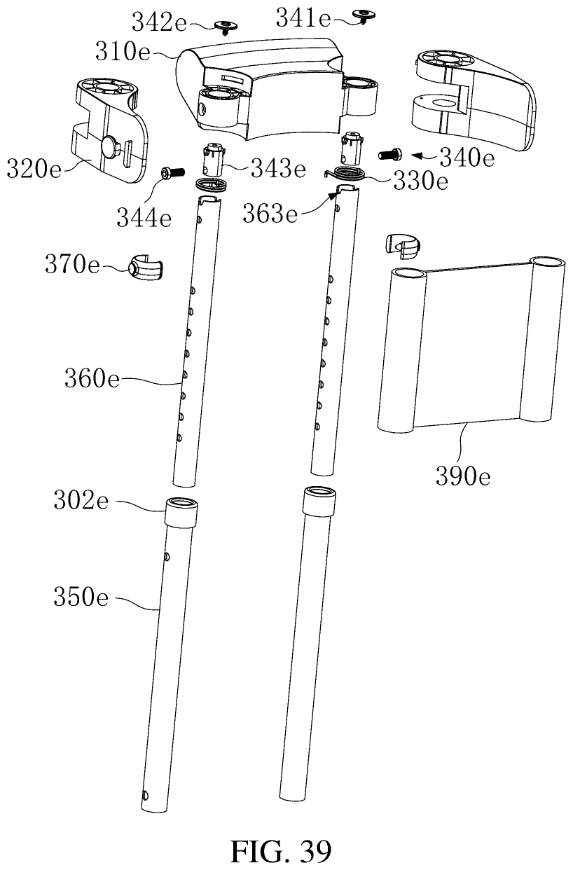

For example, the reinforcing member 343e may further include a positioning block 3434e disposed on the periphery of the first insertion portion 3436. As shown in FIG. 39, the end of the adjustment rod 360e connected to the reinforcing member 343e may define the positioning notch 363e, and the positioning block 3434e may be received in the positioning notch 363e, such that positioning between the reinforcing member 343e and the adjustment rod 360e may be achieved, and connection stability between the reinforcing member 343e and the adjustment rod 360e may be improved. For example, the reinforcing member 343e may further define a positioning slot 3433e defined in the positioning block 3434e. The sleeve portion 311e may be arranged with a positioning block, and the positioning block of the sleeve portion 311e may be received in the positioning slot 3433e. In this way, positioning of the reinforcing member 343e, the sleeve portion 311e, and the adjustment rod 360e may be achieved. The positioning block of the sleeve portion 311e may be referred to the positioning block 3132a, which will not be repeated here.

It should be noted that the plurality of protrusions 3435e on the reinforcing member 343e and the positioning hole 3434e in the present embodiment may also be arranged for the reinforcing member 343a, which will not be repeated here.

For example, at least one of the first rotation portion 322e and the second rotation portion 323e may be arranged with a second limiting structure 324e, and the bracket body 312e may be arranged with two or four first limiting structures 3121e. For example, the first rotation portion 322e may be arranged with one limiting block 324e, and the bracket body 312e may be arranged with two limiting slots 3121e. The limiting block 324e and the two limiting slots 3121e may be referred to the leg protection component 300a, which will not be repeated here.

For example, the first limiting structure 3121e and the elastic member 330e of the leg protection component 300e may respectively be arranged on the upper side and the lower side of one sleeve portion 311e.

As shown in FIG. 41, the sleeve portion 311e may further include a first mounting slot 3111e, a second mounting slot 3112e, and a third mounting slot 3113e, which are communicated with each other. The third mounting slot 3113e may be communicated with the through hole 319e.

As shown in FIG. 42, the second rotation portion 323e may include a fourth mounting slot 3232e, and a slot opening of the fourth mounting slot 3232e may face the first rotation portion 322e.

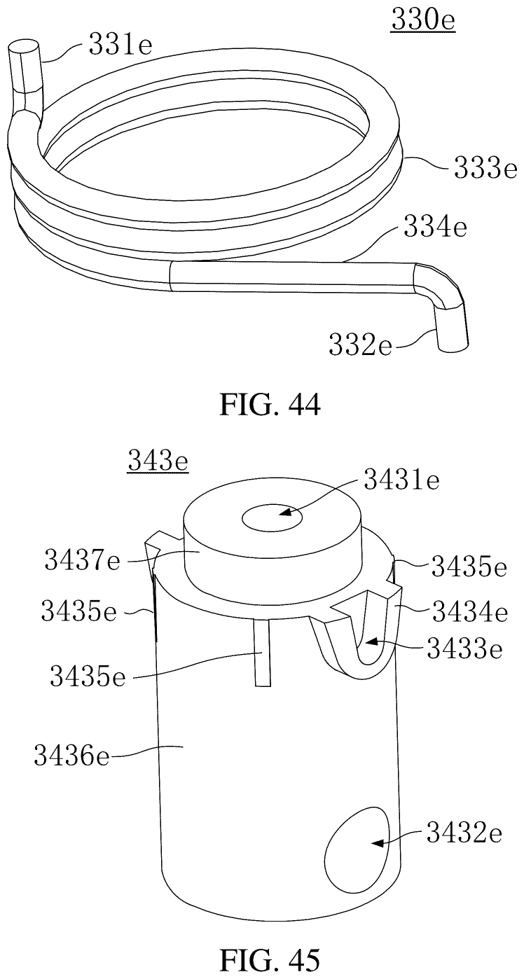

As shown in FIG. 44, the elastic member 330e may include a first elastic portion 331e, a third elastic portion 333e, a fourth elastic portion 334e, and a second elastic portion 332e, which are connected to each other in sequence. The third elastic portion 333e may be configured as an elastic annular structure having at least two elastic loops. Each of the first elastic portion 331e, the second elastic portion 332e, and the fourth elastic portion 334e may be substantially columnar. For example, the third elastic portion 333e and the fourth elastic portion 334e may be substantially parallel to each other. The first elastic portion 331e may be substantially perpendicular to the third elastic portion 333e. The second elastic portion 332e may be substantially perpendicular to the fourth elastic portion 334e. The first elastic portion 331e may be substantially parallel to the second elastic portion 332e. The first elastic portion 331e and the second elastic portion 332e may be disposed on different sides of the third elastic portion 333e.

The first elastic portion 331e may be mounted in the first mounting slot 3111e, the second elastic portion 332e may be mounted in the fourth mounting slot 3232e, the third elastic portion 333e may be mounted in the third mounting slot 3113e, and the fourth elastic portion 334e may be mounted in the second mounting slot 3112e. For example, the second mounting slot 3112 may be larger than the fourth elastic portion 334e, and the fourth elastic portion 334e may move or may be deformed elastically in the second mounting slot 3112.

The adjustment assembly 370e, the connection rod 350e, the cap 302e, and the second leg protection member 390e of the leg protection component 300e may be respectively referred to the adjustment assembly 370a, the connection rod 350a, the cap 302a, and the second leg protection member 390a of the leg protection component 300a, which will not be repeated here. The handle 314e of the leg protection bracket 310e may be referred to the handle 314a, which will not be repeated here.

For example, the leg protection component 300e may further include the stabilizing member 380a of the leg protection component 300a, which will not be repeated here.

For example, the leg protection bracket 310e may further include a plurality of reinforcing ribs 316e, which are arranged in a staggered manner to form the plurality of weight reduction holes.

Obviously, the above-described embodiments are only part of the embodiments of the present disclosure, not all of them. The drawings provide the preferred embodiments of the present disclosure, but do not limit the patent scope of the present disclosure. The present disclosure can be implemented in many different forms. On the contrary, the purpose of providing these embodiments is to make the understanding of the disclosure of the present disclosure more thorough and comprehensive. Although the present disclosure has been described in detail with reference to the foregoing embodiments, for those skilled in the art, they can still modify the technical solutions described in the foregoing specific embodiments or equivalently replace some of the technical features. Any equivalent structure made using the specification and drawings of the present disclosure, directly or indirectly applied to other related technical fields, is similarly within the patent protection scope of the present disclosure.

What is claimed is:

1. A hands-free crutch, comprising: a mounting bracket and a support foot, wherein the support foot comprises:
a bottom shell, connected to a bottom of the mounting bracket, wherein the bottom shell comprises a front section, a middle section, and a rear section; the front section, the middle section, and the rear section are sequentially connected to each other along a walking direction of a user; the front section and the rear section are both disposed away from a ground, and the middle section is disposed near the ground; and
a soft grounding member, comprising a first buffer section, a second buffer section, and a third buffer section; wherein the first buffer section is connected to the front section, the second buffer section is connected to the middle section, and the third buffer section is connected to the rear section; each of a thickness of the first buffer section and a thickness of the third buffer section is greater than a thickness of the second buffer section.

2. The hands-free crutch according to claim 1, wherein a bottom surface of the first buffer section, a bottom surface of the second buffer section, and a bottom surface of the third buffer section are connected to each other to form a horizontal contact surface for contacting the ground.

3. The hands-free crutch according to claim 1, wherein hardness of the second buffer section is greater than hardness of the first buffer section and hardness of the third buffer section.

4. The hands-free crutch according to claim 1, wherein a bottom surface of the front section, a bottom surface of the middle section, and a bottom surface of the rear section are smoothly connected to each other to form a first curved connection surface;
a top surface of the first buffer section, a top surface of the second buffer section, and a top surface of the third buffer section are smoothly connected to each other to form a second curved connection surface, a curvature of the second curved connection surface is the same as a curvature of the first curved connection surface; and the second curved connection surface is attached to the first curved connection surface.

5. The hands-free crutch according to claim 4, wherein the bottom shell defines a plurality of embedding cavities therein, the plurality of embedding cavities have openings at the first curved connection surface;
the soft grounding member is arranged with a plurality of embedding protrusions on the second curved connection surface, and each of the plurality of embedding protrusions is inserted into a respective one of the plurality of embedding cavities.

6. The hands-free crutch according to claim 5, wherein at least one of the plurality of embedding protrusions is annular.

7. The hands-free crutch according to claim 5, wherein the bottom shell defines a cavity therein, a plurality of vertically extending partition plates are arranged in the cavity; the plurality of partition plates divide the cavity into the plurality of embedding cavities.

8. The hands-free crutch according to claim 1, wherein the mounting bracket comprises: a master support rod, a top of the bottom shell defines an insertion slot, and the master support rod is inserted into the insertion slot, the insertion slot is offset from a center of the bottom shell along a length direction of the middle section.

9. The hands-free crutch according to claim 8, wherein the mounting bracket further comprises a bearing component, a vibration damping component, and a locking component;
the bearing component is configured to bear a knee and a calf and comprises a mounting rod, the mounting rod is coaxial with the master support rod and is slidably connected to the master support rod;
the vibration damping component is mounted on the master support rod; and
the locking component is mounted on the mounting rod and connected to the vibration damping component.

10. The hands-free crutch according to claim 9, wherein the locking component comprises a positioning rod, extending through and mounted on the mounting rod;
the vibration damping component comprises an upper mounting member, a lower mounting member, and an elastic member; the upper mounting member and the lower mounting member are sleevedly connected to each other; the upper mounting member and the lower mounting member are capable of moving towards or away from each other; the positioning rod extends through the upper mounting member; the lower mounting member is mounted on the master support rod, and the elastic member is disposed between the upper mounting member and the lower mounting member and is connected to the upper mounting member and the lower mounting member.

11. The hands-free crutch according to claim 10, wherein the upper mounting member comprises an upper abutting plate and an upper sleeve connected to a bottom surface of the upper abutting plate; the lower mounting member comprises a lower abutting plate and a lower sleeve connected to a top surface of the lower abutting plate; the upper sleeve is sleeved inside the lower sleeve; the elastic member is disposed inside the upper sleeve, and an upper end of the elastic member abuts against the upper abutting plate, a lower end of the elastic member abuts against the lower abutting plate; and
the positioning rod extends through the upper abutting plate, and the lower abutting plate is connected to the master support.

12. The hands-free crutch according to claim 11, wherein the upper mounting member further comprises a first snap, connected to an outer side of the upper sleeve; the lower sleeve is arranged with a vertically extending first snap slot; and the first snap is slidably received in the first snap slot; and
the lower abutting plate abuts against a top of the master support rod, the lower mounting member further comprises a second snap, connected to a bottom surface of the lower abutting plate; the master support rod defines a second snap slot, and the second snap is snapped in the second slot.

13. The hands-free crutch according to claim 11, wherein an outer side of the upper sleeve is arranged with a vertically extending guide protrusion, the lower sleeve is arranged with a vertically extending guide notch, and the guide protrusion is slidably received in the guide notch; and
the lower abutting plate is arranged with a second limiting protrusion, a top of the master support rod defines a third limiting notch, and the second limiting protrusion is received in the third limiting notch.

14. The hands-free crutch according to claim 1, wherein the mounting bracket further comprises a bearing component, configured to bear a knee and a calf, the bearing component comprises a mounting rod and a bearing member; the mounting rod is connected to the master support rod, the bearing member is configured to bear and abut against the knee, a top surface of the bearing member is concavely curved, and the top surface of the bearing member defines a first groove corresponding to the knee.

15. The hands-free crutch according to claim 14, wherein the bearing component further comprises a soft buffer pad, mounted on the bearing member; a top surface of the soft buffer pad defines a second groove corresponding to the first groove; the top surface of the soft buffer pad further defines a third groove extending along a length direction of the soft buffer pad; the third groove is communicated with the second groove.

16. The hands-free crutch according to claim 1, further comprising a leg protection component, configured to protect a thigh, wherein the leg protection component comprises:
a leg protection bracket;
at least one rotation member, being rotatably connected to the leg protection bracket; and
at least one elastic member, being mounted between the leg protection bracket and the at least one rotation member;
wherein the at least one rotation member, when rotating relative to the leg protection bracket, is configured to drive the at least one elastic member to be elastically deformed.

17. The hands-free crutch according to claim 16, wherein the elastic member comprises a first elastic portion and a second elastic portion connected to the first elastic portion; the first elastic portion is mounted on the leg protection bracket, and at least a portion of the second elastic portion extends to an outside of the leg protection bracket and is connected to the at least one rotation member.

18. The hands-free crutch according to claim 17, wherein the elastic member further comprises a third elastic portion mounted on the leg protection bracket, the third elastic portion is connected to the first elastic portion and the second elastic portion; and the third elastic portion is ring-shaped or spiral-shaped.

19. The hands-free crutch according to claim 18, wherein the leg protection bracket defines a first mounting slot, a second mounting slot, and a third mounting slot; the first mounting slot, the second mounting slot, and the third mounting slot are communicated with each other; the first elastic portion is received in the first mounting slot, and the third elastic portion is received in the third mounting slot; the second mounting slot has an opening defined in a side wall of the leg protection bracket, at least a portion of the second elastic portion passes through the second mounting slot to extend to an outside of the leg protection bracket.

20. The hands-free crutch according to claim 19, wherein the leg protection bracket further comprises a limiting column, the third elastic portion sleeves the limiting column; the third mounting slot is ring-shaped and surrounds the limiting column.
